(19) United States
(12) Patent Application Publication
(10) Pub. No.: US 2025/0028129 A1
(43) Pub. Date: Jan. 23, 2025

(54) OPTICAL MODULE

(71) Applicant: HISENSE BROADBAND MULTIMEDIA TECHNOLOGIES CO., LTD., Qingdao (CN)

(72) Inventors: Xuxia LIU, Qingdao (CN); He ZHAO, Qingdao (CN); Sigeng YANG, Qingdao (CN); Fenglai WANG, Qingdao (CN); Xiangyu DING, Qingdao (CN); Hao TIAN, Qingdao (CN); Hongchao PAN, Qingdao (CN); Jianwei MU, Qingdao (CN); Wei CUI, Qingdao (CN); Yaxun CHI, Qingdao (CN)

(73) Assignee: HISENSE BROADBAND MULTIMEDIA TECHNOLOGIES CO., LTD., Qingdao (CN)

(21) Appl. No.: 18/757,462

(22) Filed: Jun. 27, 2024

Related U.S. Application Data
(63) Continuation of application No. PCT/CN2024/090125, filed on Apr. 26, 2024.

(30) Foreign Application Priority Data
Jul. 21, 2023 (CN) 2023 2 1941203.1
Sep. 8, 2023 (CN) 2023 1 1158160.4
Oct. 8, 2023 (CN) 2023 2 2693819.8
Mar. 19, 2024 (CN) 2024 2 0534117.7

(51) Int. Cl. G02B 6/42

(52) U.S. Cl. CPC G02B 6/4214

(57) ABSTRACT

This disclosure provides an optical module including a lens assembly and an optical fiber holder. One end of the lens assembly is provided with a wrapping cavity, in which a second lens is disposed. An optical fiber is inserted in the optical fiber holder, with a gap formed between a fiber end-face of the optical fiber and the second lens. The fiber end-face of the optical fiber and a first end face of the optical fiber holder are inclined surfaces. The wrapping cavity includes a stop protrusion. A surface of the stop protrusion facing towards the optical fiber holder is an inclined stop surface, which is in contact with the first end face. The stop surface and the first end face of the optical fiber holder are inclined surfaces, achieving connection between the optical fiber holder and the lens assembly along a length direction of the lens assembly.

### CROSS-REFERENCE TO RELATED APPLICATIONS

This application is a continuation application of PCT/CN2024/090125 filed on Apr. 26, 2024, which claims priorities to: the application Ser. No. 202420534117.7, filed with the China National Intellectual Property Administration on Mar. 19, 2024; the application Ser. No. 202321941203.1, filed with the China National Intellectual Property Administration on Jul. 21, 2023; the application Ser. No. 202311158160.4, filed with the China National Intellectual Property Administration on Sep. 8, 2023; and the application Ser. No. 202322693819.8, filed with the China National Intellectual Property Administration on Oct. 8, 2023, all of which are incorporated herein by reference in their entirety.

### FIELD OF THE INVENTION

This disclosure relates to the field of optical communication technology, and in particular, to an optical module.

### BACKGROUND OF THE INVENTION

With development of new business and application mode such as cloud computing, mobile internet, and videos, development of optical communication technology has become increasingly important. In the optical communication technology, optical module is a tool for achieving mutual conversion between an optical signal and an electric signal, and is one of key devices in the optical communication equipment. Moreover, with the development of optical communication technology, it is required that transmission rate of the optical module continues to increase.

### SUMMARY OF THE INVENTION

This disclosure provides an optical module, including:
a circuit board, on which an optical chip is disposed;
a lens assembly covered on the optical chip, wherein an inner surface of the lens assembly that faces towards the optical chip is provided with a first lens, an outer surface of the lens assembly that faces away from the circuit board is provided with a reflective surface, one end of the lens assembly is provided with a wrapping cavity, and a second lens is disposed in the wrapping cavity; and
an optical fiber holder, in which an optical fiber is inserted, wherein the optical fiber holder is inserted in the wrapping cavity to be connected to the lens assembly, and wherein
there is a gap between a fiber end-face of the optical fiber and the second lens, both a first end face of the optical fiber holder and the fiber end-face are inclined surfaces, the wrapping cavity includes a stop protrusion, a surface of the stop protrusion that faces towards the optical fiber holder is a stop surface, and the stop surface is an inclined surface and is in contact with and connected with the first end face of the optical fiber holder; and
an optical signal emitted by the optical chip is transmitted to the fiber end-face through the first lens, the reflective surface and the second lens.

This disclosure further provides an optical module, including:
a circuit board, on which an optical chip is disposed;
a lens assembly covered on the optical chip, wherein an inner surface of the lens assembly that faces towards the optical chip is provided with a first lens, an outer surface of the lens assembly that faces away from the circuit board is provided with a reflective surface; the lens assembly is provided with a second lens and a wrapping cavity, the wrapping cavity is disposed on an end of the lens assembly, an optical fiber holder wrapping an optical fiber is disposed in the wrapping cavity; an inner end portion of the wrapping cavity is provided with a stop surface, which is located between the second lens and the optical fiber holder; the stop surface is in contact with a first end face of the optical fiber holder; there is a gap between a fiber end-face of the optical fiber and the second lens, and both the first end face and the fiber end-face are inclined surfaces of the same angle; the stop surface is an inclined surface, and angles of the stop surface and the fiber end-face are the same; and
an optical signal emitted by the optical chip is transmitted to the fiber end-face through the first lens, the reflective surface and the second lens.

### BRIEF DESCRIPTION OF THE DRAWINGS

To more clearly describe technical solutions of the embodiments of this disclosure, the accompanying drawings required in the description of the embodiments or the prior art are briefly illustrated below. Apparently, the accompanying drawings in the description below are merely some embodiments of this disclosure, and other accompanying drawings may also be obtained by one of ordinary skills in the art according to these accompanying drawings without creative efforts.

FIG. 1 is a partial structural diagram of an optical communication system according to some embodiments of this disclosure;

FIG. 2 is a partial structural diagram of a master computer according to some embodiments of this disclosure;

FIG. 3 is a structural diagram of an optical module according to some embodiments of this disclosure;

FIG. 4 is an exploded diagram of an optical module according to some embodiments of this disclosure;

FIG. 5 is an exploded diagram of an optical transceiver component and a circuit board according to some embodiments of this disclosure;

FIG. 6 is a sectional view of an optical transceiver component and an optical chip according to some embodiments of this disclosure;

FIG. 7 is an exploded diagram of an optical transceiver component according to some embodiments of this disclosure;

FIG. 8 is a structural diagram of an optical fiber array in a visual angle according to some embodiments of this disclosure;

FIG. 9 is a structural diagram of an optical fiber array in another visual angle according to some embodiments of this disclosure;

FIG. 10 is a structural diagram of a lens assembly in a visual angle according to some embodiments of this disclosure;

FIG. 11 is a structural diagram of a lens assembly in another visual angle according to some embodiments of this disclosure;

FIG. 12 is a sectional view of a lens assembly in a visual angle according to some embodiments of this disclosure;

FIG. 13 is a sectional view of an optical transceiver component in a visual angle according to some embodiments of this disclosure;

FIG. 14 is a sectional view of a lens assembly in another visual angle according to some embodiments of this disclosure;

FIG. 15 is a sectional view of an optical transceiver component in another visual angle according to some embodiments of this disclosure;

FIG. 16 is an assembly diagram of a circuit board, a first lens assembly and a second lens assembly according to some embodiments of this disclosure;

FIG. 17 is a diagram showing an optical path of a first lens assembly according to some embodiments of this disclosure;

FIG. 18 is an exploded diagram of a circuit board, a first lens assembly, and a second lens assembly according to some embodiments of this disclosure;

FIG. 19 is a structural diagram of a first lens assembly in a first visual angle according to some embodiments of this disclosure;

FIG. 20 is a sectional view of a first lens assembly according to some embodiments of this disclosure;

FIG. 21 is a structural diagram of a ferrule according to some embodiments of this disclosure;

FIG. 22 is a sectional assembly view of a first lens assembly and a ferrule according to some embodiments of this disclosure;

FIG. 23 is a diagram showing an optical path of a reflective mirror according to some embodiments of this disclosure;

FIG. 24 is a sectional view of another first lens assembly according to some embodiments of this disclosure;

FIG. 25 is a structural diagram of another ferrule according to some embodiments of this disclosure;

FIG. 26 is a sectional view of an assembly of another first lens assembly and another ferrule according to some embodiments of this disclosure;

FIG. 27 is a first schematic structural diagram of a lower shell part according to some embodiments of this disclosure;

FIG. 28 is a second schematic structural diagram of a lower shell part according to some embodiments of this disclosure;

FIG. 29 is a first schematic structural diagram showing a section of a lower shell part according to some embodiments of this disclosure;

FIG. 30 is a schematic structural diagram of a metal clamping member according to some embodiments of this disclosure;

FIG. 31 is a schematic structural diagram of an optical transceiver component according to some embodiments of this disclosure;

FIG. 32 is a schematic diagram showing a connection between an optical transceiver component and a lower shell part according to some embodiments of this disclosure;

FIG. 33 is a schematic diagram showing a connection between an optical transceiver component, a metal clamping member and a lower shell part according to some embodiments of this disclosure;

FIG. 34 is a schematic sectional view of a metal clamping member, a lower shell part and an optical transceiver component according to some embodiments of this disclosure;

FIG. 35 is a first schematic structural diagram of an upper shell part according to some embodiments of this disclosure;

FIG. 36 is a second schematic structural diagram of an upper shell part according to some embodiments of this disclosure;

FIG. 37 is a schematic sectional view of an upper shell part and a lower shell part according to some embodiments of this disclosure;

FIG. 38 is a schematic structural diagram of a circuit board and an optical transceiver component according to some embodiments of this disclosure;

FIG. 39 is a schematic diagram showing a local section of an optical module according to some embodiments of this disclosure;

FIG. 40 is a partial schematic structural diagram of an optical module according to some embodiments of this disclosure;

FIG. 41 is a schematic diagram showing a partial signal flow of an optical module according to some embodiments of this disclosure;

FIG. 42 is a schematic structural diagram of an MCU according to some embodiments of this disclosure;

FIG. 43 is a schematic diagram showing a signal flow of an optical module according to some embodiments of this disclosure;

FIG. 44 is a second partial structural diagram of an optical module according to some embodiments of this disclosure; and

FIG. 45 is a third schematic structural diagram of an optical module according to some embodiments of this disclosure.

### DETAILED DESCRIPTION OF THE EMBODIMENTS

Some embodiments of this disclosure will be described clearly and in detail with reference to the accompanying drawings below. However, these embodiments are merely some, but not all, of the embodiments of this disclosure. All other embodiments derived by one of ordinary skills in the art according to the embodiments provided in this disclosure fall within the protection scope of this disclosure.

Unless otherwise stated in the context, in the whole specification and the claims, the term “include” is to be interpreted as open and inclusive, meaning “including, but not limited to”; the terms “first”, “second”, and the like, cannot be understood as indicating or implying relative importance or indicating an upper limit on quantity; the term “a plurality of” or “multiple” means two or more than two; the term “connect” should be broadly understood, for example, it may be a fixed connection, a detachable connection, or an integrated connection, or it may be a direct connection, or an indirect connection through an intermediate medium; use of the term “applicable to” or “configured to” implies open and inclusive languages, which does not exclude devices that are applicable or configured to perform additional tasks or steps; the terms “parallel”, “vertical”, “identical”, “consistent”, “flush”, and the like, are not limited to absolute mathematical theoretical relationships, but also include acceptable error ranges generated in practice, and further include differences that are based on the same design concept but are caused due to manufacturing reasons.

In optical communication technology, to establish information transmission between information processing devices, information is loaded onto light, such that transmission of information is achieved through propagation of light. Herein, the light loaded with information is an optical signal. Loss of optical power may be reduced when the optical signal is propagated in information transmission devices. Therefore, high-speed, long-distance, and low-cost information transmission may be achieved. Signals that can be recognized and processed by the information processing devices are electrical signals. Generally, the information processing device includes an optical network unit (ONU), a gateway, a router, a switch, a mobile phone, a computer, a server, a tablet computer, a television, and the like. The information transmission device generally includes an optical fiber and an optical waveguide.

The optical module may achieve mutual conversion of an optical signal and an electrical signal between the information processing device and an information transmission device. For example, an optical fiber is connected to an optical signal-input end or an optical signal-output end of an optical module, and an optical network terminal is connected to an electrical signal-input end or an electrical signal-output end of the optical module. A first optical signal from the optical fiber is transmitted to the optical module, which converts the first optical signal into a first electrical signal, and transmits the first electrical signal to the optical network terminal. A second electrical signal from the optical network terminal is transmitted to the optical module, which converts the second electrical signal into a second optical signal, and transmits the second optical signal to the optical fiber. Since information may be transmitted among a plurality of information processing devices through electrical signals, at least one of the plurality of information processing devices is needed to be directly connected to the optical module, and it is unnecessary for all information processing devices to be directly connected to the optical module. Herein, the information processing device directly connected to the optical module is referred to as a master computer of the optical module. In addition, the optical signal-input end or the optical signal-output end of the optical module may be referred to as an optical port, and the electrical signal-input end or the electrical signal-output end of the optical module may be referred to as an electrical port.

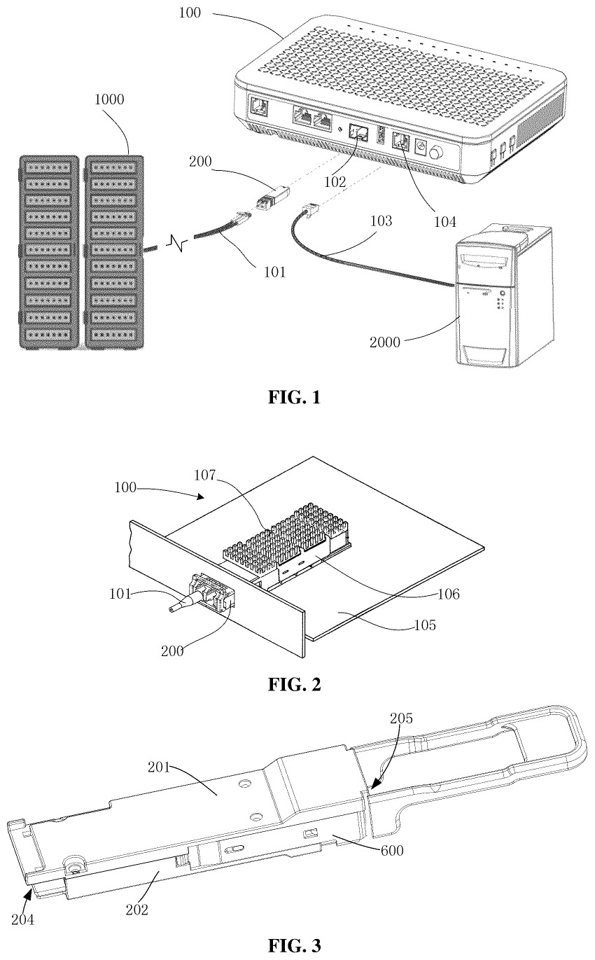

FIG. 1 is a partial structural diagram of an optical communication system according to some embodiments of this disclosure. As shown in FIG. 1, the optical communication system mainly includes a remote information processing device 1000, a local information processing device 2000, a master computer 100, an optical module 200, an optical fiber 101 and a network cable 103.

One end of the optical fiber 101 extends towards the remote information processing device 1000, and the other end thereof is connected to the optical module 200 through an optical port of the optical module 200. An optical signal may undergo a total reflection in the optical fiber 101, and propagation of the optical signal in a total reflection direction may almost maintain original optical power. The optical signal undergoes a plurality of total reflections in the optical fiber 101, such that the optical signal from the remote information processing device 1000 is transmitted into the optical module 200, or the optical signal from the optical module 200 is transmitted to the remote information processing device 1000, thereby achieving long-distance information transmission with low power loss.

The optical communication system may include one or more optical fibers 101, which may be detachably or fixedly connected to the optical module 200. The master computer 100 is configured to provide data signals to the optical module 200, receive data signals from the optical module 200, or monitor or control a working status of the optical module 200.

The master computer 100 includes a housing with a roughly rectangular shape, and an optical module interface 102 disposed on the housing. The optical module interface 102 is configured to couple the optical module 200, thereby establishing a unidirectional/bidirectional electrical signal connection between the master computer 100 and the optical module 200.

The master computer 100 also includes an external electrical interface, which may couple an electrical signal network. For example, the external electrical interface includes a universal serial bus (USB) or a network cable interface 104. The network cable interface 104 is configured to couple the network cable 103, thereby establishing a unidirectional or bidirectional electrical signal connection between the master computer 100 and the network cable 103. One end of the network cable 103 is connected to the local information processing device 2000, and the other end thereof is connected to the master computer 100, thereby establishing an electrical signal connection between the local information processing device 2000 and the master computer 100 through the network cable 103. For example, a third electrical signal sent by the local information processing device 2000 is transmitted to the master computer 100 through the network cable 103. The master computer 100 generates a second electrical signal based on the third electrical signal, and the second electrical signal from the master computer 100 is transmitted to the optical module 200. The optical module 200 converts the second electrical signal into a second optical signal, and transmits the second optical signal to the optical fiber 101. The second optical signal is transmitted to the remote information processing device 1000 through the optical fiber 101. For example, a first optical signal from the remote information processing device 1000 is propagated through the optical fiber 101. The first optical signal from the optical fiber 101 is transmitted to the optical module 200. The optical module 200 converts the first optical signal into a first electrical signal, and transmits the first electrical signal to the master computer 100. The master computer 100 generates a fourth electrical signal based on the first electrical signal, and transmits the fourth electrical signal to the local information processing device 2000. It should be noted that, the optical module is a tool for achieving conversion between optical and electrical signals. During the conversion between optical and electrical signals as described above, the information is unchanged, but methods for encoding and decoding the information may be changed.

In addition to the optical network terminal, the master computer 100 also includes an optical line terminal (OLT), an optical network terminal (ONT), a data center server, or the like.

FIG. 2 is a partial structural diagram of a master computer according to some embodiments of this disclosure. To clearly display a connection relationship between the optical module 200 and the master computer 100, FIG. 2 only shows a structure of the master computer 100 that is related to the optical module 200. As shown in FIG. 2, the master computer 100 further includes a PCB circuit board 105 disposed within the housing, a cage 106 disposed on a surface of the PCB circuit board 105, a radiator 107 disposed on the cage 106, and an electrical connector disposed inside the cage 106. The electrical connector is configured to be coupled to an electric port of the optical module 200. The radiator 107 has a raised structure, such as a fin, for increasing a heat dissipation area.

The optical module 200 is inserted into the cage 106 of the master computer 100 and is fixed via the cage 106. Thus, heat generated by the optical module 200 is conducted to the cage 106, and then dissipated through the radiator 107. After the optical module 200 is inserted into the cage 106, the electrical port of the optical module 200 is connected to the electrical connector inside the cage 106, thereby establishing a bidirectional electrical signal connection between the optical module 200 and the master computer 100. In addition, the optical port of the optical module 200 is connected to the optical fiber 101, thereby establishing a bidirectional optical signal connection between the optical module 200 and the optical fiber 101.

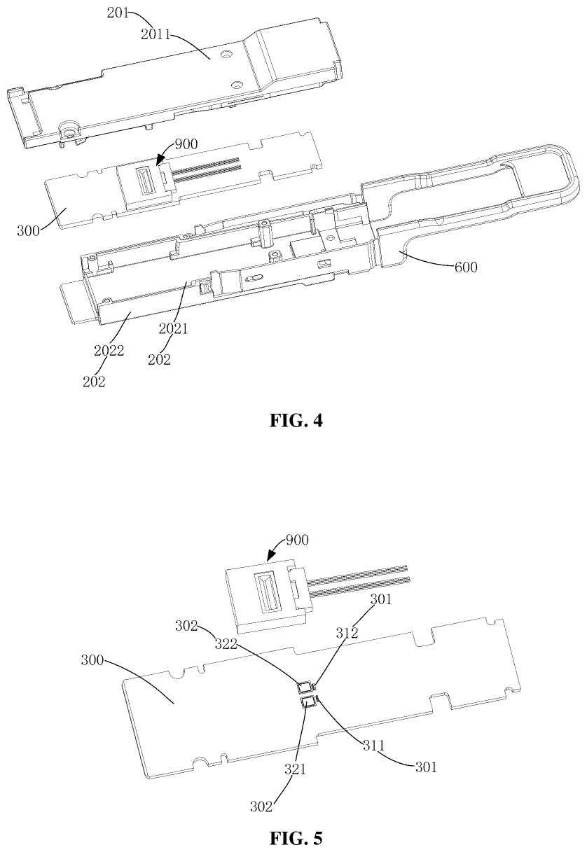

FIG. 3 is a structural diagram of an optical module according to some embodiments of this disclosure. FIG. 4 is an exploded diagram of an optical module according to some embodiments of this disclosure. As shown in FIG. 3 and FIG. 4, the optical module 200 includes a shell, and a circuit board 300 and an optical transceiver component 900 that are disposed inside the shell.

The shell includes an upper shell part 201 and a lower shell part 202. The upper shell part 201 is covered on the lower shell part 202 to form the shell having two openings 204 and 205. An outer contour of the shell is generally in a cuboid shape.

In some embodiments, the lower shell part 202 includes a bottom plate 2021 and two lower side plates 2022 located on two sides of the bottom plate 2021 and disposed perpendicular to the bottom plate 2021. The upper shell part 201 includes a cover plate 2011. The cover plate 2011 is covered on the two lower side plates 2022 of the low shell part 202, to form the shell.

In some embodiments, the lower shell part 202 includes a bottom plate 2021 and two lower side plates 2022 located on two sides of the bottom plate 2021 and disposed perpendicular to the bottom plate 2021. The upper shell part 201 includes a cover plate 2011 and two upper side plates located on two sides of the cover plate 2011 and disposed perpendicular to the cover plate 2011. The two upper side plates are combined with the two lower side plates 2022 so as to achieve the covering of the upper shell part 201 on the lower shell part 202.

A direction along a connection line of the two openings 204 and 205 may be consistent or inconsistent with a length direction of the optical module 200. For example, the opening 204 is located at an end portion (a right end in FIG. 3) of the optical module 200, and the opening 205 is also located at an end portion (a left end in FIG. 3) of the optical module 200. Alternatively, the opening 204 is located at the end portion of the optical module 200, while the opening 205 is located at a side portion of the optical module 200. The opening 204 is an electrical port, and a golden finger of the circuit board 300 extends out of the electrical port and can be inserted into the electrical connector of the master computer 100. The opening 205 is an optical port configured to be coupled to the external optical fiber 101, such that the optical fiber 101 is connected to the optical transceiver component 900 inside the optical module 200.

The assembling way in which the upper shell part 201 is combined with the lower shell part 202 facilitates to mount the circuit board 300, the optical transceiver component 900, and the like, into the shell, such that these components are encapsulated and protected via the upper shell part 201 and the lower shell part 202. In addition, when assembling the circuit board 300, the optical transceiver component 900, or the like, it is easier to deploy a positioning part, a heat dissipation part, and an electromagnetic shielding part of these components, which facilitates implementation of automate production.

In some embodiments, the upper shell part 201 and the lower shell part 202 are made of metal materials, being conducive to achieving electromagnetic shielding and heat dissipation.

In some embodiments, the optical module 200 further includes an unlocking part 600 located outside the shell thereof. The unlocking part 600 is configured to achieve a fixed connection between the optical module 200 and the master computer, or to release the fixed connection between the optical module 200 and the master computer.

For example, the unlocking part 600 is located outside the two lower side plates 2022 of the lower shell part 202, and includes a snap-fitting part that matches the cage 106 of the master computer 100. When the optical module 200 is inserted into the cage 106, the snap-fitting part of the unlocking part 600 secures the optical module 200 in the cage 106. When the unlocking part 600 is pulled, the snap-fitting part of the unlocking part 600 is moved accordingly, and thus a connection relationship between the snap-fitting part and the master computer is changed, thereby releasing securing between the optical module 200 and the master computer, such that the optical module 200 can be drawn out of the cage 106.

The circuit board 300 includes a circuit cable, an electronic element, and a chip. The electronic element is connected to the chip according to a circuit design via the circuit wiring, to implement functions such as power supply, electrical signal transmission, and grounding. For example, the electronic element may include a capacitor, a resistor, a transistor, and a metal-oxide-semiconductor field-effect transistor (MOSFET). For example, the chip may include a microcontroller unit (MCU), a laser driver chip, a transimpedance amplifier (TIA), a limiting amplifier (LIA), a clock and data recovery (CDR) chip, a power management chip, and a digital signal processing (DSP) chip.

The circuit board 300 is generally a rigid circuit board. Also, the rigid circuit board may act as a carrying member due to its relatively hard material. For example, a rigid circuit board may steadily carry the above mentioned electronic element and chip thereon. Furthermore, the rigid circuit board may be inserted into the electrical connector in the cage 106 of the master computer 100.

The circuit board 300 further includes a golden finger formed on a surface at an end portion thereof. The golden finger is composed of a plurality of independent pins. The circuit board 300 is inserted into the cage 106, and is electrically connected to the electrical connector in the cage 106 via the golden finger. The golden finger may be disposed only on a surface of one side of the circuit board 300 (such as an upper surface shown in FIG. 4); or may be disposed on surfaces of upper and lower sides of the circuit board 300 to provide a larger quantity of pins, thereby adapting to a situation that requires a large quantity of pins. The golden finger is configured to establish an electrical connection with the master computer, to implement power supply, grounding, inter-integrated circuit (I2C) signal transmission, data signal transmission, and the like. Certainly, a flexible circuit board may also be used in some optical modules. The flexible circuit board is generally used in cooperation with the rigid circuit board, to serve as a supplement to the rigid circuit board.

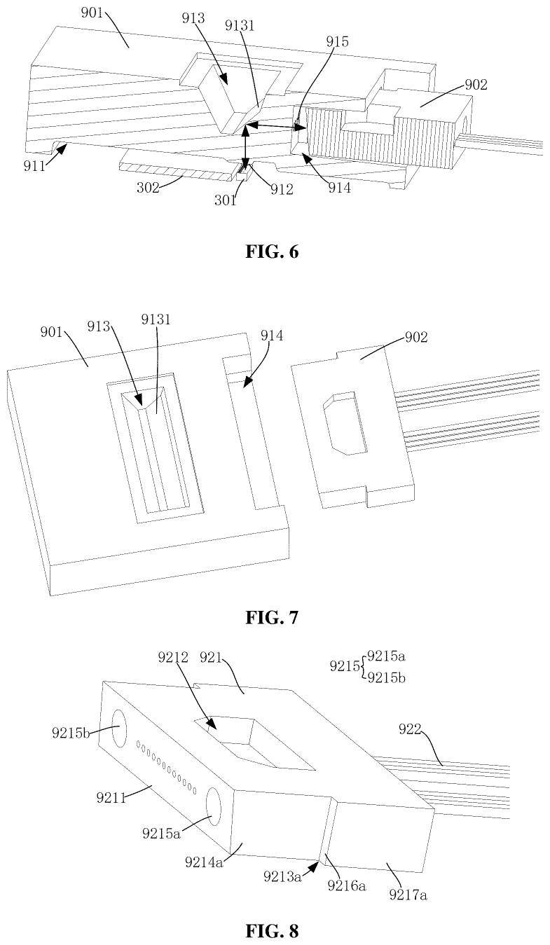

FIG. 5 is an exploded diagram of an optical transceiver component and a circuit board according to some embodiments of this disclosure. FIG. 6 is a sectional view of an optical transceiver component and an optical chip according to some embodiments of this disclosure. As shown in FIG. 5 and FIG. 6, in some embodiments, an optical chip 301 may be disposed on the circuit board 300, and the optical chip 301 may be attached onto the circuit board 300.

The optical chip 301 may include an optical emission chip 311, which may emit an emission optical signal. A light emitting surface of the optical emission chip 311 may be located on a top surface of the optical emission chip 311, such that a light beam emitted by the optical emission chip is perpendicular to the circuit board 300.

The optical chip 301 may include an optical reception chip 312, which may receive the optical signal. The optical reception chip 312 and the optical emission chip 311 may be fixed on the circuit board 300 side by side. A light entering surface of the optical reception chip 312 may be located on a top surface of the optical reception chip 312, such that a light beam received by the optical reception chip 312 is perpendicular to the circuit board 300.

The optical chip 301 is attached on the circuit board 300, and a light emitting surface or a light entering surface thereof is located on the top surface of the optical chip 301. In this way, the light beam emitted by the optical emission chip is perpendicular to the circuit board 300, and the light beam received by the optical reception chip is perpendicular to the circuit board 300.

The optical fiber 101 connected to the optical module is parallel to the circuit board 300, therefore it needs to change transmission directions of the light beam emitted by the optical emission chip and an external light beam transmitted to the optical reception chip. Therefore, the optical transceiver component 900 is provided to change direction of the light beam emitted by the optical emission chip such that the light beam emitted by the optical emission chip is reflected through a lens assembly, the reflected light beam is parallel to the circuit board 300, thereby facilitating incident of the reflected light beam into the optical fiber; and the received light beam transmitted by the external optical fiber is reflected through the lens assembly, and the reflected light beam is perpendicular to the circuit board 300, thereby facilitating reception by the optical reception chip.

As shown in FIG. 5 and FIG. 6, an optical matching chip 302 may be disposed on the circuit board 300.

The optical matching chip 302 may include a laser driver chip 321. The laser driver chip 321 may be bonded on the circuit board 300 through silver adhesive, which provides functions such as fixing and heat dissipation. Subsequently, the bare chip is electrically connected with the circuit board 300 through gold wire bonding.

The optical matching chip 302 may include a TIA chip 322. The TIA chip 322 may be bonded on the circuit board 300 through silver adhesive, which provides functions such as fixing and heat dissipation. Subsequently, the bare chip is electrically connected to the circuit board 300 through gold wire bonding.

As shown in FIG. 6, in some embodiments, a first lens 912 is disposed on a surface of the optical transceiver component 900 that faces towards the circuit board 300. The first lens 912 may be located above the optical chip 301, so as to collimate a light beam emitted by the optical emission chip 311 and couple a light beam to be incident to the optical reception chip 312.

In some embodiments, a reflective surface 9131 may be disposed on a surface of the optical transceiver component 900 that faces away from the circuit board 300. The reflective surface 9131 may be located above the first lens 912, so as to change a transmission direction of light beam incident to the reflective surface 9131. For example, a light beam transmitted upwards vertically (that is, a light beam collimated by the first lens 912) is reflected by the reflective surface 9131 and then becomes a light beam transmitted rightwards horizontally. A light beam transmitted leftwards horizontally is reflected by the reflective surface 9131 and then becomes a light beam transmitted downwards vertically (that is, a light beam incident onto the first lens 912).

In some embodiments, a second lens 915 may be disposed on a surface of the optical transceiver component 900 that faces towards the optical port. The second lens 915 may be located between the reflective surface 9131 and the optical fiber, so as to couple the light beam reflected by the reflective surface 9131 and transmit the light beam to the optical fiber, and to collimate a reflected light beam transmitted from the optical fiber.

In some examples, the optical emission chip 311 emits a light beam upwards, and the light beam is collimated by an emission collimating lens of the first lens 912. The collimated light beam is transmitted onto the reflective surface 9131 for reflection. The reflected light beam is coupled by an emission coupling lens of the second lens 915 and then is transmitted to the optical fiber.

In some examples, the light beam transmitted from the optical fiber is collimated by a reception collimating lens of the second lens 915. The collimated light beam is reflected by the reflective surface. The reflected light beam is transmitted vertically downwards, and is coupled by a reception coupling lens of the first lens 912 to be vertically incident to the optical reception chip 312.

FIG. 7 is an exploded diagram of an optical transceiver component according to some embodiments of this disclosure. As shown in FIG. 5, FIG. 6 and FIG. 7, in some embodiments, the optical transceiver component 900 may include a lens assembly 901. The lens assembly 901 may be covered on the circuit board 300.

In some examples, a bottom portion of the lens assembly 901 may be provided with a covering groove 911. The covering groove 911 may be formed by a side of the lens assembly 901 that faces towards the circuit board 300 recessed in a direction away from the circuit board 300. A covering cavity may be formed by the covering groove 911 and the circuit board 300. The optical chip 301 and the optical matching chip 302 may be disposed within the covering cavity.

In some examples, a groove (not shown in the figures) may be disposed on the circuit board 300. The lens assembly 901 may be covered on the groove.

In some examples, the lens assembly 901 is covered on the groove, and the lens assembly 901 and the circuit board 300 encloses a covering cavity.

In some examples, the optical chip 301 may be disposed in the groove.

In some examples, the optical matching chip 302 may be disposed in the groove.

In some examples, a top portion of the lens assembly 901 may be provided with an optical port groove 913. The optical port groove 913 may be formed by a side of the lens assembly 901 that is away from the circuit board 300 recessed in a direction towards the circuit board 300. A side wall of the optical port groove 913 may be designed to be the reflective surface 9131.

In some examples, one end of the lens assembly 901 may be provided with a wrapping cavity 914. The wrapping cavity 914 may have an opening. A second lens 915 may be disposed in the wrapping cavity 914.

In some examples, the wrapping cavity 914 may include a polygonal cavity.

In some examples, the wrapping cavity 914 may include a cylindrical cavity.

As shown in FIG. 6 and FIG. 7, in some embodiments, the optical transceiver component 900 may include an optical fiber array 902. One end of the optical fiber array 902 may be inserted into the wrapping cavity 914 through the opening of the wrapping cavity 914, such that the optical fiber array 902 is optically connected to the lens assembly 901.

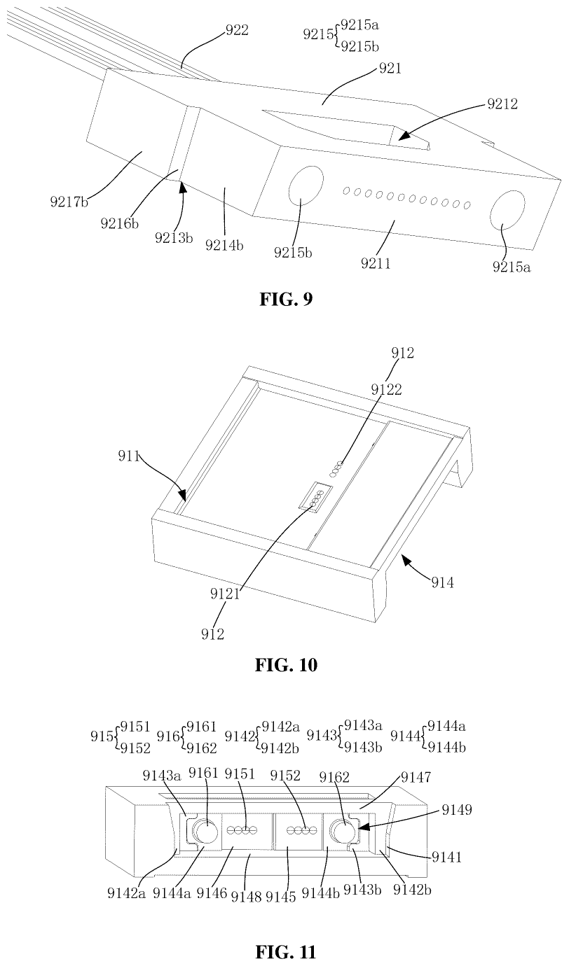

FIG. 8 is a structural diagram of an optical fiber array in a visual angle according to some embodiments of this disclosure. FIG. 9 is a structural diagram of an optical fiber array in another visual angle according to some embodiments of this disclosure. As shown in FIG. 8 and FIG. 9, in some embodiments, the optical fiber array 902 may include an optical fiber 922. A tail end face of the optical fiber 922 may be located at a focal point of the second lens 915, such that the optical fiber 922 is optically connected to the second lens 915. Thus, the light beam is coupled by the second lens 915 and then is incident onto the optical fiber 922, or the second lens 915 collimates the light beam transmitted from the optical fiber 922.

In some examples, the optical fiber array 902 may include one optical fiber 922.

In some examples, the optical fiber array 902 may include a plurality of optical fibers 922.

Hereinafter, description is made by using an example in which the optical fiber array 902 includes a plurality of optical fibers 922.

In some embodiments, one end of the optical fiber array 902 may include a tail end face of an optical fiber holder 921.

In some embodiments, one end of the optical fiber array 902 may include a portion of side surfaces of the optical fiber holder 921 that is connected with the tail end face of the optical fiber holder 921.

In some examples, because there is a gap between the second lens 915 and a fiber end-face of the optical fiber 922, when an optical signal is incident from the second lens 915 onto the fiber end-face of the optical fiber, the optical signal may be reflected at the fiber end-face of the optical fiber due to changes of media, causing the reflected optical signal enters the lens assembly 901 again along an original path, resulting in interference with the optical signal.

To address this problem, in some embodiments, the fiber end-face of the optical fiber 922 may be an inclined surface. Since the fiber end-face of the optical fiber 922 is an inclined surface, when the optical signal reflected by the lens assembly 901 is incident onto the fiber end-face of the optical fiber 922, the reflected light may be reflected to other places according to an angle of the inclined surface, instead of entering the lens assembly 901 along its original path. Thus, interference of the reflected light is reduced.

In some embodiments, an angle between the fiber end-face of the optical fiber 922 and a side surface of the optical fiber 922 may be 3˜13°. For example, the angle between the fiber end-face of the optical fiber 922 and the side surface of the optical fiber 922 is 3˜8° or 9˜13°, and an angle between the fiber end-face and the corresponding side surface of the optical fiber is 8°.

As shown in FIG. 8 and FIG. 9, in some embodiments, the optical fiber array 902 may include the optical fiber holder 921. The optical fiber holder 921 may wrap the optical fiber 922, such that the optical fiber 922 and the optical fiber holder 921 constitute the optical fiber array 902. The optical fiber holder 921 may be inserted into the lens assembly 901 through the opening of the wrapping cavity 914, to achieve connection of the optical fiber array 902 with the lens assembly 901.

In some examples, the optical fiber holder 921 may be provided with a positioning hole 9215, which may be disposed corresponding to a positioning column of the lens assembly 901. The positioning column of the lens assembly 901 may be inserted into the positioning hole 9215 so as to position and mount the optical fiber array 902.

In some examples, the positioning hole 9215 may run through the optical fiber holder 921.

In some examples, the positioning hole 9215 may include a first positioning hole 9215a.

In some examples, the positioning hole 9215 may include a second positioning hole 9215b.

In some examples, the tail end face of the optical fiber holder 921 may be provided with an optical fiber hole. A front end face of the optical fiber holder 921 (a surface opposite to the tail end face of the optical fiber holder 921) is provided with an optical fiber-insertion hole. The optical fiber-insertion hole may communicate with the optical fiber hole, such that the optical fiber 922 is inserted through the optical fiber-insertion hole into the optical fiber hole. Thus, the optical fiber 922 passes through the optical fiber holder 921. The fiber end-face of the optical fiber 922 may be located inside the optical fiber holder 921, or may be protruded out of the tail end face of the optical fiber holder 921.

In some embodiments, the optical fiber 922 may include a first optical fiber, which may be disposed corresponding to an emission coupling lens of the second lens 915, such that an optical signal emitted by the optical emission chip is coupled to the first optical fiber via the emission coupling lens of the second lens 915.

There is at least one first optical fiber, and there is at least one emission coupling lens. The quantity of the first optical fiber is the same as that of the emission coupling lens, such that the first optical fiber is disposed in one-to-one correspondence to the emission coupling lens.

In some embodiments, the optical fiber 922 may include a second optical fiber, which may be disposed corresponding to a reception collimating lens of the second lens 915, such that light from the second optical fiber is incident into the optical reception chip after being collimated through the reception collimating lens of the second lens 915.

There is at least one second optical fiber, and there is at least one reception collimating lens. The number of the second optical fiber is the same as that of the reception collimating lens, such that the second optical fiber is disposed in one-to-one correspondence to the reception collimating lens.

The optical fiber 922 is inserted into the optical fiber holder 921 through the optical fiber-insertion hole, and gaps between the optical fiber 922 and the optical fiber-insertion hole are sealed by using sealing adhesive. The sealing adhesive is applied to a periphery where the optical fiber 922 is in contact with the optical fiber-insertion hole, and may be accumulated on the optical fiber 922 and the front end face of the optical fiber holder 921. A sealing colloid is formed after the sealing adhesive is solidified, thereby preventing a coolant from flowing into the optical fiber holder 921 through the optical fiber-insertion hole.

In some examples, an upper end of the optical fiber holder 921 may be provided with an observation hole 9212. The observation hole 9212 may communicate with the optical fiber hole in the optical fiber holder 921 such that one may observe the insertion of the optical fiber 922 into the optical fiber holder 921 through the observation hole 9212.

In some examples, after the optical fiber 922 is inserted into the optical fiber holder 921 through the optical fiber-insertion hole, the sealing adhesive may be applied to the observation hole 9212 to form a sealing colloid, thereby sealing the observation hole 9212 with the sealing colloid, thus preventing the coolant from seeping into the optical fiber holder 921 through the observation hole 9212.

As shown in FIG. 8 and FIG. 9, the optical fiber holder 921 may include a first end face 9211, which may be the tail end face of the optical fiber holder 921.

In some embodiments, the fiber end-face of the optical fiber 922 protrudes from the tail end face (that is, the first end face 9211) of the optical fiber holder 921. The fiber end-face of the optical fiber 922 is directly cut via a cutting process, such that the fiber end-face of the optical fiber 922 becomes an inclined surface. For the optical fiber array 902 in such situation, there is no need to make the tail end face of the optical fiber holder 921 an inclined surface.

In some embodiments, the fiber end-face of the optical fiber 922 does not protrude from the tail end face (that is, the first end face 9211) of the optical fiber holder 921.

In some embodiments, the fiber end-face of the optical fiber 922 and the first end face 9211 of the optical fiber holder 921 may be ground separately according to a grinding process, such that the fiber end-face of the optical fiber 922 and the first end face 9211 of the optical fiber holder 921 are both inclined surfaces.

In some examples, inclination angles of the fiber end-face of the optical fiber 922 and the first end face 9211 of the optical fiber holder 921 may be different. In other words, the fiber end-face of the optical fiber 922 may not be parallel to the first end face 9211 of the optical fiber holder 921.

In some examples, the inclination angles of the fiber end-face of the optical fiber 922 and the first end face 9211 of the optical fiber holder 921 may be the same. In other words, the fiber end-face of the optical fiber 922 may be parallel to the first end face 9211 of the optical fiber holder 921.

The inclination angles of the fiber end-face of the optical fiber 922 and the first end face 9211 of the optical fiber holder 921 are the same, so as to facilitate processing of the optical fiber array 902, and also facilitate cooperation between the optical fiber 922 of the optical fiber array 902 and the second lens 915 of the lens assembly 901.

In some examples, during a process of grinding the fiber end-face of the optical fiber 922 and the first end face 9211 of the optical fiber holder 921, it only needs to ensure that a region of the first end face 9211 of the optical fiber holder 921 where the fiber end-face of the optical fiber is located is ground.

In some examples, as for an optical fiber holder having a relatively thin thickness, the first end face 9211 of the optical fiber holder 921 may be fully ground, without leaving a step surface.

In some examples, the first end face 9211 of the optical fiber holder 921 may include a grinding surface, which is an inclined surface. As shown in FIG. 8 and FIG. 9, the first end face 9211 may be the grinding surface. A vertical distance between an upper edge of the first end face 9211 and a fifth side surface 9216b is greater than a vertical distance between a lower edge of the first end face 9211 and the fifth side surface 9216b, such that the first end face 9211 is disposed inclindedly relative to the circuit board 300.

In some examples, as for an optical fiber holder with a relatively thick thickness, the first end face 9211 of the optical fiber holder 921 may not be fully ground. As a result, there may be a step surface.

In some examples, the first end face 9211 of the optical fiber holder 921 may include a step surface. Angles of the grinding surface and the step surface may be different.

In some examples, the grinding surface may be an inclined surface.

In some examples, the step surface may be a vertical surface.

As shown in FIG. 8 and FIG. 9, the optical fiber holder 921 may include a first side surface 9214a. One end of the first side surface 9214a may be connected with one end of the first end face 9211.

As shown in FIG. 8 and FIG. 9, the optical fiber holder 921 may include a second side surface 9216a. One end of the second side surface 9216a may be connected with the other end of the first side surface 9214a. An included angle between the second side surface 9216a and the first side surface 9214a is greater than 0°, such that the second side surface 9216a and the first side surface 9214a forms a first gap 9213a. For example, the included angle between the second side surface 9216a and the first side surface 9214a is 90°. In other words, the second side surface 9216a is disposed perpendicular to the first side surface 9214a.

As shown in FIG. 8 and FIG. 9, the optical fiber holder 921 may include a third side surface 9217a. One end of the third side surface 9217a may be connected with the other end of the second side surface 9216a. The third side surface 9217a is protruded outwards relative to the first side surface 9214a such that the first gap 9213a is less than or equal to 90°, thereby making the first gap 9213a face towards the lens assembly 901.

As shown in FIG. 8 and FIG. 9, the optical fiber holder 921 may include a fourth side surface 9214b. One end of the fourth side surface 9214b may be connected with the other end of the first end face 9211.

As shown in FIG. 8 and FIG. 9, the optical fiber holder 921 may include a fifth side surface 9216b. One end of the fifth side surface 9216b may be connected with the other end of the fourth side surface 9214b. An included angle between the fifth side surface 9216b and the fourth side surface 9214b is greater than 0°, such that a second gap 9213b is formed by the fifth side surface 9216b and the fourth side surface 9214b.

For example, the included angle between the fifth side surface 9216b and the fourth side surface 9214b is 90°. In other words, the fifth side surface 9216b is disposed perpendicular to the fourth side surface 9214b.

As shown in FIG. 8 and FIG. 9, the optical fiber holder 921 may include a sixth side surface 9217b. One end of the sixth side surface 9217b may be connected with the other end of the fifth side surface 9216b. The sixth side surface 9217b is protruded outwards relative to the fifth side surface 9216b such that the second gap 9213b is less than or equal to 90°, thereby making the second gap 9213a face towards the lens assembly 901.

The first gap 9213a and the second gap 9213b may be located on two sides of the optical fiber holder 921. The first gap 9213a and the second gap 9213b may form a gap 9213, to facilitate grasping of the optical fiber holder 921 during machining of the optical fiber array 902. The gap 9213 may face towards the lens assembly 901.

FIG. 10 is a structural diagram of a lens assembly in a visual angle according to some embodiments of this disclosure. As shown in FIG. 10, in some embodiments, the first lens 912 may be disposed on a top portion of the covering groove 911 of the lens assembly 901.

In some examples, the first lens 912 may include an emission collimating lens 9121, which may be located above the optical emission chip 311. The emission collimating lens 9121 may collimate a light beam emitted by the optical emission chip 311.

In some examples, the first lens 912 may include a reception coupling lens 9122, which may be located above the optical reception chip 312. The reception coupling lens 9122 may couple the light beam reflected by the reflective surface 9131 and incident the same to the optical reception chip 312.

In some examples, a plane where the emission collimating lens 9121 is located may be higher than a height of the reception coupling lens 9122, such that an emitted light beam emitted by the light emitting surface of the optical emission chip 311 is collimated by the first lens 912, and a received light beam is coupled to be incident onto a photosensitive surface of the optical reception chip 312.

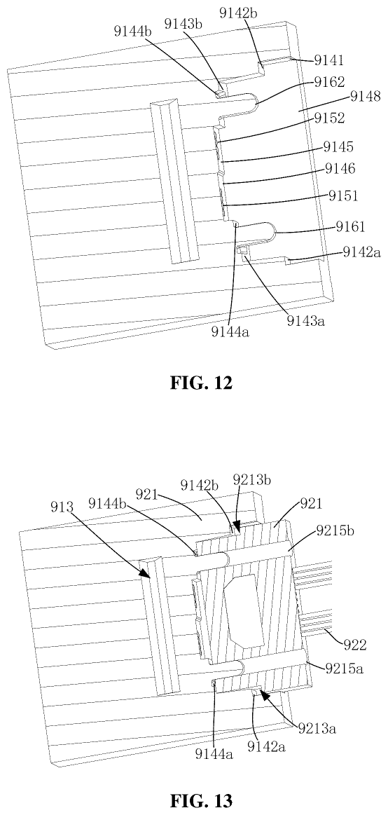

FIG. 11 is a structural diagram of a lens assembly in another visual angle according to some embodiments of this disclosure. FIG. 12 is a sectional view of a lens assembly in a visual angle according to some embodiments of this disclosure. FIG. 13 is a sectional view of an optical transceiver component in a visual angle according to some embodiments of this disclosure. As shown in FIG. 11, FIG. 12 and FIG. 13, in some embodiments, a positioning column 916 may be disposed in the wrapping cavity 914. The positioning column 916 may be disposed corresponding to the positioning hole 9215 of the optical fiber holder 921, such that the positioning column 916 can be inserted into the positioning hole 9215, thereby achieving connections between the optical fiber array 902 and the lens assembly 901 in an up-down direction (a height direction of the lens assembly 901) and a front-rear direction (a width direction of the lens assembly 901).

In some examples, the positioning column 916 may include a first positioning column 9161. The first positioning column 9161 may be disposed corresponding to the first positioning hole 9215a, such that the first positioning column 9161 is inserted into the first positioning hole 9215a.

In some examples, the positioning column 916 may include a second positioning column 9162. The positioning column 916 may be disposed corresponding to the second positioning hole 9215b, so as to be inserted into the second positioning hole 9215b.

As shown in FIG. 11, FIG. 12 and FIG. 13, in some embodiments, the second lens 915 may be disposed in the wrapping cavity 914. The second lens 915 may be located between the first positioning column 9161 and the second positioning column 9162.

The second lens 915 may include an emission coupling lens 9151, which may couple the light beam reflected from the reflective surface 9131, such that the light beam is incident onto the fiber end-face of the optical fiber 922.

The second lens 915 may include a reception collimating lens 9152, which may collimate the light beam in the optical fiber 922.

As shown in FIG. 11, in some embodiments, the wrapping activity 914 may include a support plate 9148.

As shown in FIG. 11, FIG. 12 and FIG. 13, in some embodiments, the wrapping activity 914 may include an avoidance plate, which may be connected to the support plate 9148.

As shown in FIG. 11, FIG. 12 and FIG. 13, in some embodiments, the avoidance plate may include a first avoidance plate 9141. The first avoidance plate 9141 may be connected to one side of the support plate 9148, and may be disposed corresponding to the sixth side surface 9217b of the optical fiber holder 921.

As shown in FIG. 11, FIG. 12 and FIG. 13, the avoidance plate may include a second avoidance plate. The second avoidance plate may be disposed opposite to the first avoidance plate 9141, may be connected to the other side of the support plate 9148, and may be disposed corresponding to the third side surface 9217a of the optical fiber holder 921.

The first avoidance plate 9141, the support plate 9148 and the second avoidance plate may form a U-shaped first accommodation recess.

As shown in FIG. 11, FIG. 12 and FIG. 13, in some embodiments, the wrapping activity 914 may include a limiting plate 9142. The limiting plate 9142 may be connected to the support plate 9148, and may be disposed corresponding to the gap 9213 of the optical fiber holder 921.

A first side surface of the limiting plate 9142 may be connected to the avoidance plate, and may be disposed corresponding to the second side surface 9216a of the optical fiber holder 921 or the fifth side surface 9216b of the optical fiber holder 921.

A second side surface of the limiting plate 9142 may be away from the avoidance plate, and may be disposed corresponding to the first side surface 9214a of the optical fiber holder 921 or the fourth side surface 9214b of the optical fiber holder 921.

In some examples, the limiting plate 9142 may include a first limiting plate 9142a. A first side surface of the first limiting plate 9142a may be connected to the second avoidance plate. The first limiting plate 9142a may be disposed corresponding to the first gap 9213a of the optical fiber holder 921.

In some examples, the limiting plate 9142 may include a second limiting plate 9142b, which may be disposed corresponding to the second gap 9213b of the optical fiber holder 921. A side surface of the second limiting plate 9142b may be connected to the first avoidance plate 9141. The second limiting plate 9142b and the first limiting plate 9142a may be located on two sides of the wrapping cavity 914.

The first limiting plate 9142a, the support plate 9148 and the second limiting plate 9142b may form a U-shaped second accommodation recess.

In some embodiments, the second side surface of the limiting plate 9142 may be protruded inwards relative to the avoidance plate, thereby reducing a width dimension of a first accommodation through hole.

In some embodiments, a second side surface of the first limiting plate 9142a may be protruded inwards relative to the first avoidance plate.

In some embodiments, a second side surface of the second limiting plate 9142b may be protruded inwards relative to the second avoidance plate.

The second side surface of the first limiting plate 9142a may be protruded inwards relative to the first avoidance plate, and the second side surface of the second limiting plate 9142b may be protruded inwards relative to the second avoidance plate, thereby reducing the width dimension of the first accommodation through hole.

As shown in FIG. 11, in some embodiments, the wrapping activity 914 may include a cover body 9147. The cover body 9147 may be disposed opposite to the support plate 9148, and may be connected to the limiting plate 9142.

The first limiting plate 9142a, the support plate 9148, the second limiting plate 9142b and the cover body 9147 may form a homocentric squares-shaped accommodation through hole.

As shown in FIG. 11, FIG. 12 and FIG. 13, in some embodiments, the wrapping activity 914 may include a stop protrusion 9143. The stop protrusion 9143 may be located at an outer side of the positioning column 916. In other words, the stop protrusion 9143 is located outside the first positioning column 9161 and the second positioning column 9162. The stop protrusion 9143 may be disposed corresponding to the first end face 9211 of the optical fiber holder 921. A stop surface of the stop protrusion 9143 may be in contact with the first end face 9211 of the optical fiber holder 921, such that the stop protrusion 9143 may be in contact with and connected with the first end face 9211 of the optical fiber holder 921. Thus, the optical fiber holder 921 is stopped here.

In some embodiments, the stop surface of the stop protrusion 9143 is located between the second lens 915 and the optical fiber holder 921. In this way, it is ensured that there is a stable distance between the second lens 915 and the optical fiber inserted in the optical fiber holder 921 when the optical fiber holder 921 is stopped at the stop surface, and thus the light spot focused by the second lens 915 can fall on the fiber end-face of the optical fiber 922.

A side surface (that is, the stop surface) of the stop protrusion 9143 may be connected with the other side surface of the limiting plate 9142.

The first end face of the optical fiber holder 921 protrudes relative to the gap 9213, and the stop protrusion 9143 is recessed inwards relative to the limiting plate 9142, in such a way that the optical fiber holder 921 cooperates with the wrapping activity 914.

As shown in FIG. 11, in some embodiments, the stop protrusion 9143 may be provided with an avoidance opening 9149. The avoidance opening 9149 is opened towards the positioning columns 916, such that the stop protrusion 9143 avoids or makes way for the positioning columns 916 and an area of the stop protrusion 9143 is increased.

The stop protrusion 9143 may include a first stop protrusion 9143a, which may be located outside the first positioning column 9161 and the second positioning column 9162. A stop surface of the first stop protrusion 9143a may be in contact with and connected with a portion of the first end face of the optical fiber holder 921, such that the first stop protrusion 9143a may be in contact with and connected with a portion of the first end face of the optical fiber holder 921. Thus, the optical fiber holder 921 is stopped here. The stop surface of the first stop protrusion 9143a is a side surface thereof facing towards the optical fiber holder 921.

The stop protrusion 9143 may include a second stop protrusion 9143b, which may be located outside the first positioning column 9161 and the second positioning column 9162. A stop surface of the second stop protrusion 9143b may be in contact with and connected with a portion of the first end face of the optical fiber holder 921, such that the second stop protrusion 9143b may be in contact with and connected to a portion of the first end face of the optical fiber holder 921. Thus, the optical fiber holder 921 is stopped here. The stop surface of the second stop protrusion 9143b is a side surface thereof facing towards the optical fiber holder 921.

The first end face of the optical fiber holder 921 is respectively in contact with and connected with the stop surface of the first stop protrusion 9143a and the stop surface of the second stop protrusion 9143b, so as to increase a contact area between the first end face of the optical fiber holder 921 and the stop protrusion 9143, thereby improving connection stability between the optical fiber holder 921 and the lens assembly 901.

As shown in FIG. 11, FIG. 12 and FIG. 13, in some embodiments, the wrapping activity 914 may include a mounting protrusion 9144. A side surface (a fixing surface) of the mounting protrusion 9144 may be connected to the other side surface (a non-stop surface) of the stop protrusion 9143. The positioning column 916 may be fixedly disposed on the mounting protrusion 9144, thereby facilitating to control a direction of the positioning column 916.

The mounting protrusion 9144 may include a first mounting protrusion 9144a. One side surface (a fixing surface) of the first mounting protrusion 9144a may be connected to the other side surface (a non-stop surface) of the first stop protrusion 9143a. The first positioning column 9161 may be fixedly disposed on the first mounting protrusion 9144a.

The mounting protrusion 9144 may include a second mounting protrusion 9144b. One side surface (a fixing surface) of the second mounting protrusion 9144b may be connected to the other side surface (a non-stop surface) of the second stop protrusion 9143b. The second positioning column 9162 may be fixedly disposed on the second mounting protrusion 9144b.

As shown in FIG. 11, FIG. 12 and FIG. 13, in some embodiments, the wrapping activity 914 may include a mounting surface. One end of the mounting surface may be connected to the mounting protrusion. The second lens 915 may be placed on the mounting surface. The second lens 915 may be located at one side of the positioning column 916.

The second lens 915 and the stop protrusion 9143 may be located at two sides of the positioning column 916.

In some embodiments, the mounting surface may include a first mounting surface 9145. One end of the first mounting surface 9145 may be connected to the other side surface of the second mounting protrusion 9144b. The reception collimating lens 9152 may be fixedly disposed on the first mounting surface 9145.

In some embodiments, the mounting surface includes a second mounting surface 9146. One end of the second mounting surface 9146 may be connected to the other side surface of the first mounting protrusion 9144a. The emission coupling lens 9151 may be fixedly disposed on the second mounting surface 9146.

There may be a step surface between the second mounting surface 9146 and the first mounting surface 9145, such that the second mounting surface 9146 is recessed inwards relative to the first mounting surface 9145, thereby compensating for a focal length of the second lens 915.

A wrapping cavity without the cover body 9147 may accommodate thinner and thicker optical fiber holders. A wrapping cavity having the cover body 9147 may accommodate thinner optical fiber holders.

In some embodiments, the stop surface of the stop protrusion 9143 may be a vertical surface. To be specific, the stop surface of the stop protrusion 9143 is perpendicular to the circuit board 300.

For a thicker optical fiber holder, a size of the step surface of the first end face 9211 after ground may vary, and the first end face of the optical fiber holder 921 is in contact with the stop surface of the stop protrusion 9143. In this case, there may be a new problem, that is, the size of the step surface of the first end face 9211 may affect a distance L from a vertex of the second lens 915 to the fiber end-face of the optical fiber 922. The different distances L result in different distances from optimal spots to the fiber end-face. Therefore, actual spot size of the fiber end-face varies, resulting in poor consistency in specifications of the optical module.

To solve the problem of poor consistency in the specifications of the optical module, in some embodiments, the stop surface of the stop protrusion 9143 may be a non-vertical surface.

In some embodiments, the stop surface of the stop protrusion 9143 may include a first stop portion, which may be located in a region of the stop surface of the stop protrusion 9143 above a center point of the positioning column 916.

In some examples, the first stop portion may be an inclined surface.

In some examples, the first stop portion may be a recessed portion.

In some examples, the first stop portion may be a step.

In some embodiments, the stop surface of the stop protrusion 9143 may include a second stop portion, which may be located in a region of the stop surface of the stop protrusion 9143 below the center point of the positioning column 916. The second stop portion may be a vertical surface, or may be an inclined surface.

A distance between the first stop portion and the opening of the wrapping cavity 914 may be greater than a distance between the second stop portion and the opening of the wrapping cavity 914, such that the first stop portion is not in contact with the step surface of the first end face 9211 when the second stop portion is in contact with the grinding surface of the first end face 9211.

In some embodiments, an angle of the first stop portion may be the same as that of the second stop portion, such that the stop surface of the stop protrusion 9143 composed of the second stop portion and the first stop portion is an inclined surface.

Due to minor errors in production processes, in some embodiments, an angle difference between the stop surface of the stop protrusion 9143 and the first end face 9211 of the optical fiber holder 921 may be −2˜2°, such that the first stop portion is not in contact with the step surface of the first end face 9211 when the second stop portion is in contact with the grinding surface of the first end face 9211. For example, the angle difference between the stop surface of the stop protrusion 9143 and the first end face 9211 of the optical fiber holder 921 is −2˜0° or 0˜2°.

In the case that the angle difference between the stop surface of the stop protrusion 9143 and the first end face 9211 of the optical fiber holder 921 is −2˜2°, defocusing is not easy to occur. Therefore, the focused light spot falls on the fiber end-face of the optical fiber 922 as possible, which is less likely to cause optical fluctuations.

In some embodiments, the angle difference between the stop surface of the stop protrusion 9143 and the first end face 9211 of the optical fiber holder 921 may be 0°. In other words, the stop surface of the stop protrusion 9143 and the first end face 9211 of the optical fiber holder 921 are inclined surfaces parallel to each other.

In some examples, for a thinner optical fiber holder, if the stop surface of the stop protrusion 9143 and the first end face 9211 of the optical fiber holder 921 are inclined surfaces parallel to each other, contact area between the stop surface of the stop protrusion 9143 and the first end face 9211 of the optical fiber holder 921 may be increased, which may improve connection stability between the optical fiber holder 921 and the lens assembly 901 in a left-right direction (that is, a length direction of the lens assembly 901).

In some examples, for a thicker optical fiber holder, if the stop surface of the stop protrusion 9143 and the first end face 9211 of the optical fiber holder 921 are inclined surfaces parallel to each other, contact area between the stop surface of the stop protrusion 9143 and the first end face 9211 of the optical fiber holder 921 may be increased, which may improve the connection stability between the optical fiber holder 921 and the lens assembly 901 in a left-right direction (that is, the length direction of the lens assembly 901). In addition, the first stop portion is not in contact with the step surface of the first end face 9211 when the second stop portion is in contact with the grinding surface of the first end face 9211, in this case, the distances from the optimal light spot and the fiber end-face are the same, which avoids defocusing, thereby making the focused light spot completely fall on the fiber end-face.

Angles of the stop surface of the stop protrusion 9143 and the first end face 9211 of the optical fiber holder 921 are the same, and angles of the first end face 9211 of the optical fiber holder 921 and the fiber end-face of the optical fiber 922 are the same, such that the angles of the stop surface of the stop protrusion 9143, the first end face 9211 of the optical fiber holder 921 and the fiber end-face of the optical fiber 922 are all the same.

For example, the stop surface of the stop protrusion 9143, the first end face 9211 of the optical fiber holder 921 and the fiber end-face of the optical fiber 922 have the same angle of 3˜13°. The stop surface of the stop protrusion 9143, the first end face 9211 of the optical fiber holder 921 and the fiber end-face of the optical fiber 922 have the same angle of 3˜8°, of 9˜13°, or of 8°.

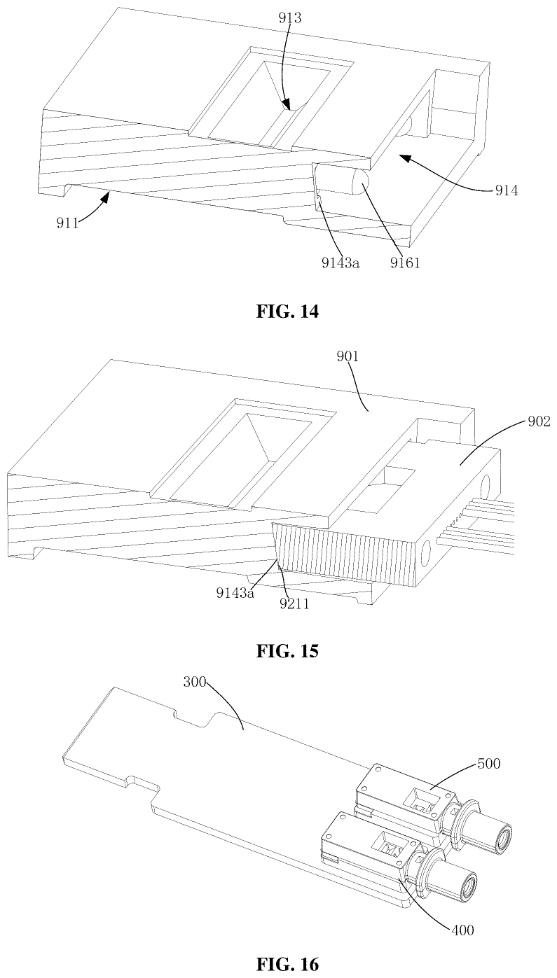

FIG. 14 is a sectional view of a lens assembly in another visual angle according to some embodiments of this disclosure. As shown in FIG. 14, the stop surface (that is, a surface facing towards the optical fiber holder 921) of the first stop protrusion 9143a is an inclined surface.

FIG. 15 is a sectional view of an optical transceiver component in another visual angle according to some embodiments of this disclosure. As shown in FIG. 15, the first end face 9211 of the optical fiber holder 921 is an inclined surface.

As shown in FIG. 15, the first end face 9211 of the optical fiber holder 921 is stopped at the first stop protrusion 9143a, and thus the first end face 9211 of the optical fiber holder 921 is stopped at the stop protrusion 9143.

In some embodiments, the optical module includes a circuit board, a lens assembly, and an optical fiber holder. An optical chip is disposed on the circuit board, and the lens assembly is covered on the optical chip. An inner surface of the lens assembly that faces towards the optical chip is provided with a first lens, and an outer surface of the lens assembly that faces away from the circuit board is provided with a reflective surface. One end of the lens assembly is provided with a wrapping cavity, in which a second lens and a positioning column are disposed. The second lens is located at one side of the positioning column. The optical fiber holder wraps the optical fiber, and a first end face of the optical fiber holder is provided with a positioning hole. The positioning column is inserted in the positioning hole, so as to achieve connection between the optical fiber holder and the lens assembly in a width direction and a height direction of the lens assembly. There is a gap between the fiber end-face of the optical fiber and the second lens, and reflection occurs when an optical signal enters the fiber end-face of the optical fiber through the second lens. To resolve this problem, the fiber end-face of the optical fiber is made as an inclined surface. Since the fiber end-face of the optical fiber is an inclined surface relative to the fiber side-face of the optical fiber, reflected light may be reflected to other places according to an angle of the fiber end-face, without returning along an original path. Thus, no interference may be caused to the optical chip. Because the fiber end-face of the optical fiber does not protrude from the first end face of the optical fiber holder, in order to make the fiber end-face of the optical fiber as an inclined surface, both the first end face of the optical fiber holder and the optical fiber needs to be ground, such that both the fiber end-face of the optical fiber and the first end face of the optical fiber holder are inclined surfaces. The wrapping cavity includes the stop protrusion, which is located at the other side of the positioning column. A surface of the stop protrusion that faces towards the optical fiber holder is the stop surface. The stop surface is in contact with and connected with the first end face, such that the optical fiber holder is stopped at the stop surface, thereby achieving connection between the optical fiber holder and the lens assembly along a length direction of the lens assembly. In some embodiments, the optical fiber holder is connected to the lens assembly through the positioning column and the positioning hole in the width direction and the height direction of the lens assembly. Both the stop surface and the first end face of the optical fiber holder are inclined surfaces, which achieves the connection between the optical fiber holder and the lens assembly in the length direction of the lens assembly.

In some examples, the wrapping cavity may be a cylindrical cavity.

In some examples, the optical fiber array may include one optical fiber.

In some examples, the lens assembly may include a first lens assembly. The first lens assembly may be covered on the optical emission chip, and may cooperate with the one optical fiber.

In some examples, the lens assembly may include a second lens assembly, which may be covered on the optical emission chip. In this case, the optical module may emit a plurality paths of optical signals.

In some examples, the second lens assembly may be covered on an optical reception chip, and may cooperate with the one optical fiber.

For ease of description, detailed description is made below by using an example in which the wrapping cavity is a cylindrical cavity.

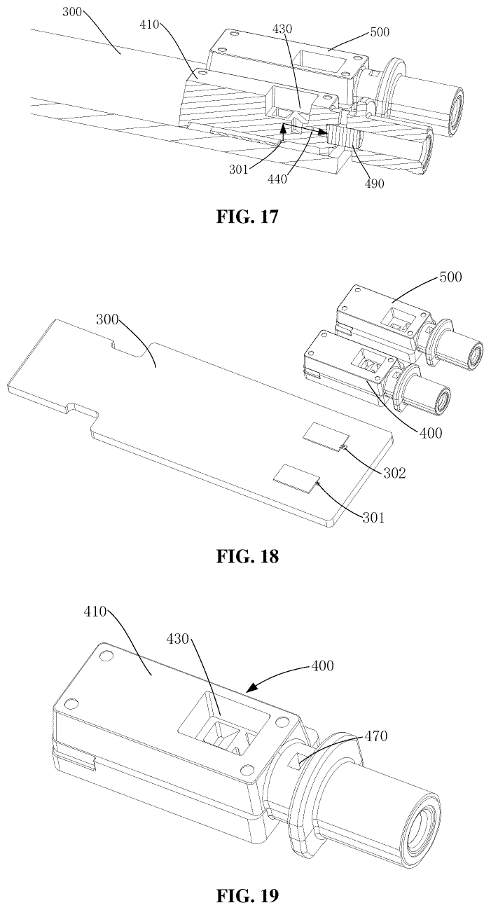

FIG. 16 is an assembly diagram of a circuit board, a first lens assembly and a second lens assembly according to some embodiments of this disclosure. FIG. 17 is a diagram showing an optical path of a first lens assembly according to some embodiments of this disclosure. FIG. 18 is an exploded diagram of a circuit board, a first lens assembly and a second lens assembly according to some embodiments of this disclosure. As shown in FIG. 16, FIG. 17 and FIG. 18, an optical emission component may include a first lens assembly 400 and a first optical fiber adapter. An end of the first optical fiber adapter is optically connected to the first lens assembly 400, and the other end thereof is optically connected to an external optical fiber. An optical signal emitted by the optical emission chip 311 is reflected by the first lens assembly 400, and then is transmitted to the first optical fiber adapter, so as to transmit the optical signal to the external.

An optical reception component includes a second lens assembly 500 and a second optical fiber adapter. One end of the second optical fiber adapter is optically connected to the second lens assembly 500, and the other end thereof is optically connected to an external optical fiber. An optical signal from the external optical fiber is transmitted to the second lens assembly through the second optical fiber adapter. The optical signal is reflected by the second lens assembly 500, and then is transmitted to the optical reception chip 312, achieving reception of an external optical signal.

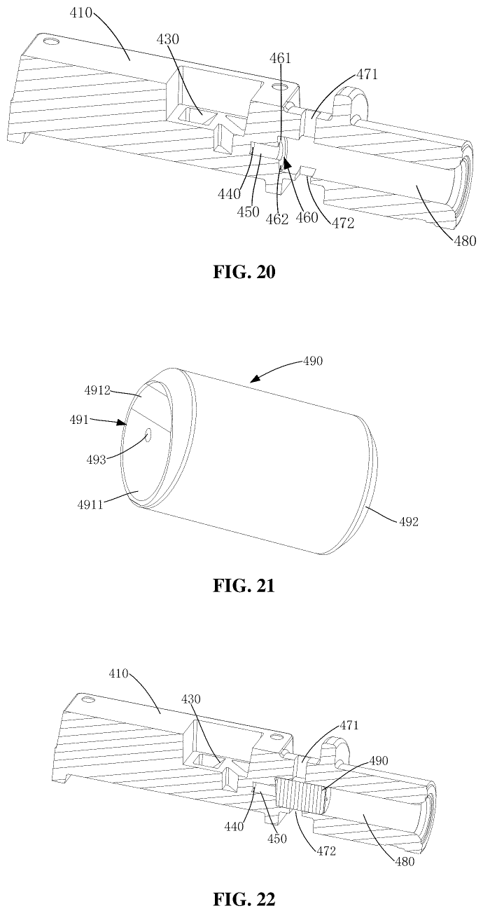

FIG. 19 is a structural diagram of a first lens assembly in a first visual angle according to some embodiments of this disclosure. FIG. 20 is a sectional view of a first lens assembly according to some embodiments of this disclosure. As shown in FIG. 19 and FIG. 20, in some examples, a through hole 450 is disposed between an optical port-cavity (also referred to as a wrapping cavity in some examples) 480 of a lens body 410 and a reflective mirror (in some examples, it may also be referred to as a reflective surface) 430. The reflective mirror 430 is communicated to the optical port-cavity 480 via the through hole 450, and one end of the through hole 450 that is close to the reflective mirror 430 is provided with a second lens 440. A diameter of the through hole 450 may be smaller than that of the optical port-cavity 480, such that a step surface is formed at a joint where the through hole 450 is connected with the optical port-cavity 480. The step surface may be a ferrule-stop surface (in some examples, it may also be referred to as a stop surface) 460.

In some embodiments, the ferrule-stop surface 460 includes a first ferrule-stop portion (in some examples, it may also be referred to as a first stop portion) 461 and a second ferrule-stop portion (in some examples, it may also be referred to as a second stop portion) 462. The first ferrule-stop portion 461 is located above the through hole 450, and the second ferrule-stop portion 462 is located below the through hole 450.

The lens body 410 is also provided with a dispensing slot 470, which is communicated with the optical port-cavity 480 for injecting adhesive into the optical port-cavity 480 through the dispensing slot 470.

In some embodiments, the dispensing slot 470 includes a first dispensing slot 471 and a second dispensing slot 472 that are disposed opposite to each other. An opening of the first hanging slot 471 faces upwards, and an opening of the second dispensing slot 472 faces downwards. The opening of the first dispensing slot 471 faces upwards, such that adhesive may be applied to an upper outer surface of the ferrule through the first dispensing slot 471 with the opening facing upwards, so as to bond an upper portion of the ferrule with an inner side face of the optical port-cavity 480 through the adhesive. The opening of the second dispensing slot 472 faces downwards, such that adhesive may be applied to a lower outer surface of the ferrule through the second dispensing slot 472 with the opening facing downwards, so as to bond a lower portion of the ferrule with the inner side face of the optical port-cavity 480 through the adhesive. By applying adhesive to the outer surface of the ferrule through the first dispensing slot 471 and the second dispensing slot 472 that are disposed opposite to each other, the adhesive may be applied on the outer surface of the ferrule without rotating the ferrule, thereby improving connection firmness between the ferrule and the optical port-cavity 480.

FIG. 21 is a structural diagram of a ferrule according to some embodiments of this disclosure. FIG. 22 is a sectional assembly view of a first lens assembly and a ferrule according to some embodiments of this disclosure. As shown in FIG. 21 and FIG. 22, a ferrule 490 is inserted in the optical port-cavity 480 of the lens body 410, and an end face of the ferrule 490 that faces towards the second lens 440 is in contact with the ferrule-stop surface 460. In this way, the second lens 440 converges the optical signal into a light spot, which falls in an optical fiber 493 of the ferrule 490. The ferrule 490 is inserted in the optical port-cavity 480. After the end face of the ferrule is in contact with the ferrule-stop surface 460, adhesive is injected into the optical port-cavity 480 through the dispensing slot 470, and the adhesive is applied to the outer surface of the ferrule 490, so as to fix the outer surface of the ferrule 490 with the inner side face of the optical port-cavity 480 through the adhesive, thereby fixing the ferrule 490 in the optical port-cavity 480.

In some examples, the ferrule 490 and the optical fiber holder 921 mentioned in the above examples are the same component having different configurations, that is, they both are configured to insert the optical fiber, such that the optical fiber is inserted into the wrapping cavity 480. Referring to FIG. 15, the optical fiber holder 921 may have a cuboid structure and is configured such that multiple optical fibers may be inserted in it. Referring to FIG. 25, the ferrule 490 may have a cylindrical structure and is configured such that one optical fiber may be inserted in it.

After being inserted into the optical port-cavity 480 through an opening at an end of the optical port-cavity 480, the ferrule 490 is moved leftwards along the optical port-cavity 480 until an end face of the ferrule 490 is in contact with the ferrule-stop surface 460. A side surface 492 of the ferrule 490 that is away from the second lens 440 is perpendicular to the circuit board 300, and is in close contact with and is coupled with an internal optical fiber inserted in the optical port-cavity 480, achieving connection between the ferrule 490 and the internal optical fiber. In this way, a light beam from the second lens 440 is converged to an optical fiber 493 in the ferrule 490, and then is transmitted to the internal optical fiber through the optical fiber 493, achieving emission of light.

In some embodiments, the ferrule 490 is pre-arranged in the optical port-cavity 480 of the lens body 410, and an fiber end-face of the optical fiber 493 in the ferrule 490 is processed as an inclined surface, so as to prevent an optical signal, of the converged light, that is reflected at the fiber end-face from returning to the first lens 400 along its original path. Then, the internal optical fiber is inserted into the optical port-cavity 480, and is physically in close contact with and is aligned with the other side surface 492 of the ferrule 490. In this way, there is no need to process the end face of the internal optical fiber that is inserted into the optical port-cavity 480, and it only needs to insert the end face of the internal optical fiber into the optical port-cavity 480 and align it with the side surface 492 of the ferrule 490.

In some embodiments, the internal optical fiber is inserted in the ferrule 490, and an fiber end-face of the internal optical fiber flushes with the end face of the ferrule 490. Then, the ferrule 490 wrapping the internal optical fiber is inserted into the optical port-cavity 480 through the opening at an end of the optical port-cavity, and is moved leftwards along the optical port-cavity 480 until the end face of the ferrule 490 is in contact with the ferrule-stop surface 460. Then, adhesive may be injected to the outer surface of the ferrule 490 through the dispensing slot 470. The adhesive is coated on the outer surface of the ferrule 490, such that the outer surface of the ferrule 490 is fixed to the inner side face of the optical port-cavity 480 through the adhesive, thereby fixing the ferrule 490 in the optical port-cavity 480.

The ferrule 490 is made of a ceramic material, and the optical fiber 493 is fixed in the optical port-cavity 480 through the ceramic ferrule. Compared to a plastic member wrapping the optical fiber 493, the ceramic ferrule has higher processing accuracy. After being fixed in the optical port-cavity 480 through the adhesive, the ferrule 490 cannot move easily. In this way, stability of the optical fiber 493 is improved, and an optical signal from the second lens 440 can be better converged in the optical fiber 493, thereby improving convergence accuracy of the optical signal.

To make the fiber end-face of the optical fiber 493 an inclined surface, in some embodiments, the optical fiber 493 is arranged in the ferrule 490, and is extended out of the end face 491 of the ferrule 490 (that is, a side surface of the ferrule 490 that faces towards the ferrule-stop surface 460). The fiber end-face of the optical fiber 493 is ground to be an inclined surface.

The ferrule 490 and the ferrule-stop surface 460 are both vertical surfaces perpendicular to the circuit board 300. The optical fiber 493 extends out of the end face of the ferrule 490, and the fiber end-face of the optical fiber 493 is an inclined surface. After light converged by the second lens 440 is reflected by the fiber end-face, the reflected light may be reflected to other places according to an angle of the inclined surface, instead of returning along an original path. Thus, impact of the reflected light on the optical emission chip is reduced. When the end face 491 of the ferrule 490 is in contact with the ferrule-stop surface 460, the fiber end-face is located within the through hole 450. A length of the through hole 450 is prolonged, that is, the ferrule-stop surface 460 is moved towards the optical port-cavity, so as to ensure a distance between the second lens 440 and the fiber end-face, that is, ensure that the light spot converged by the second lens 440 falls on the fiber end-face.

To make the fiber end-face of the optical fiber 493 an inclined surface, in some embodiments, the optical fiber 493 is disposed in the ferrule 490 and is not extended out of the end face 491 of the ferrule 490. The fiber end-face and the end face of the ferrule 490 are ground separately, such that the end face 491 of the ferrule 490 and the fiber end-face are both inclined surfaces. The end face 491 of the ferrule 490 is not parallel to the fiber end-face.

To make the fiber end-face of the optical fiber 493 an inclined surface, in some embodiments, the optical fiber 493 is disposed in the ferrule 490, and is not extended out of the end face 491 of the ferrule 490. The fiber end-face is ground together with the end face 491 of the ferrule 490, such that both the end face 491 of the ferrule 490 and the fiber end-face are inclined surfaces. Moreover, the end face 491 of the ferrule 490 is parallel to the fiber end-face.

During the process of grinding the fiber end-face and the end face 491 of the ferrule 490, it is merely needed to ensure that a region of the ferrule 490 where the optical fiber is located is ground. The entire end face 491 of the ferrule 490 may not be completely ground, and thus a step surface may be left. To be specific, the end face of the ferrule 490 includes a grinding surface 4911 and a step surface 4912, which have different angles. The grinding surface 4911 is an inclined surface, and the step surface 4912 is a vertical surface. A size of the step surface 4912 is not fixed, provided that performance indicators of the fiber end-face are met according to process requirements. Due to uncertainty of grinding times, the size of the step surface 4912 left after the grinding process is also variable.

In some embodiments, the ferrule-stop surface 460 is a vertical surface (that is, the ferrule-stop surface 460 and the circuit board 300 are perpendicular to each other), and the end face 491 of the ferrule 490 is in contact with the ferrule-stop surface 460, that is, the step surface 4912 of the ferrule 490 is in contact with the ferrule-stop surface 460. However, the size of the step surface 4912 left from the grinding varies, and the ferrule-stop surface 460 is in contact with the step surface 4912, which may cause a new problem, to be specific, the size of the step surface 4912 may affect the distance L from the vertex of the second lens 440 to the fiber end-face. Different values of the L results in inconsistent distances from the optimal spots to the fiber end-face. Therefore, the actual spot size of the fiber end-face varies, resulting in poor consistency of the specifications of the optical modules.

To resolve this problem, a distance between the first ferrule-stop portion 461 and the opening of the optical port-cavity 480 is greater than a distance between the second ferrule-stop portion 462 and the opening of the optical port-cavity 480, such that the second ferrule-stop portion 462 is in contact with the grinding surface 4911 while the first ferrule-stop portion 461 is not in contact with the step surface 4912. Thus, the size of the step on the end face of the ferrule does not affect the distance between the vertex of the second lens and the fiber end-face, ensuring that a distance between the fiber end-face and the second lens remains unchanged. In this case, the actual spot size of the fiber end-face remains the same, thereby improving the consistency of the specifications of the optical module.

In some embodiments, the second ferrule-stop portion 462 is a vertical surface, and the first ferrule-stop portion 461 is an inclined surface. The distance between the first ferrule-stop portion 461 and the opening of the optical port-cavity 480 is greater than that between the second ferrule-stop portion 462 and the opening of the optical port-cavity 480, such that the first ferrule-stop portion 461 is not in contact with the step surface 4912 when the second ferrule-stop portion 462 is in contact with the grinding surface 4911.

In some embodiments, the second ferrule-stop portion 462 is a vertical surface, and the first ferrule-stop portion 461 is recessed. The distance between the first ferrule-stop portion 461 and the opening of the optical port-cavity 480 is greater than that between the second ferrule-stop portion 462 and the opening of the optical port-cavity 480, such that the first ferrule-stop portion 461 is not in contact with the step surface 4912 when the second ferrule-stop portion 462 is in contact with the grinding surface 4911.

In some embodiments, the second ferrule-stop portion 462 is a vertical surface, and the first ferrule-stop portion 461 has a plurality of steps. The distance between the first ferrule-stop portion 461 and the opening of the optical port-cavity 480 is greater than that between the second ferrule-stop portion 462 and the opening of the optical port-cavity 480, such that the first ferrule-stop portion 461 is not in contact with the step surface 4912 when the second ferrule-stop portion 462 is in contact with the grinding surface 4911.

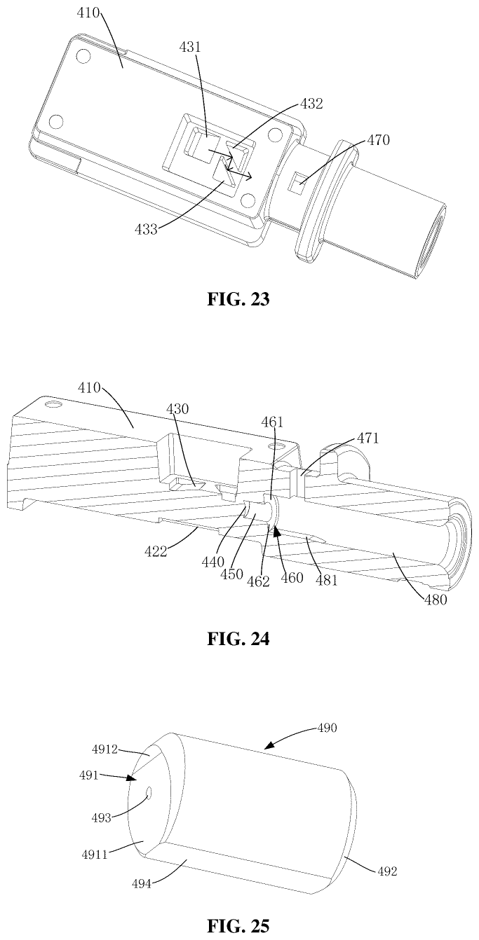

FIG. 23 is a diagram illustrating an optical path of a reflective mirror according to some embodiments of this disclosure. As shown in FIG. 23, in some embodiments, the reflective mirror 430 includes a first reflective mirror 431, a second reflective mirror 432 and a third reflective mirror 433. The first reflective mirror 431 is disposed directly above the first lens 422 and is configured to reflect a collimated light, that is emitted by the first lens 422 and is perpendicular to the circuit board 300, to be a collimated light parallel to the circuit board 300. The second reflective mirror 432 is disposed at a right side of the first reflective mirror 431 (that is, the second reflective mirror is closer to the optical port than the first reflective mirror 431). The third reflective mirror 433 is disposed at a rear side of the second reflective mirror 432, and a central axis of the third reflective mirror 433 coincides with that of the optical port-cavity 480. The second reflective mirror 432 is configured to reflect the reflected light parallel to the circuit board 300 to the third reflective mirror 433, which in turn reflects the collimated light to the second lens 440.

After being inserted in the optical port-cavity 480 through the opening at one end of the optical port-cavity 480, the ferrule 490 is moved leftwards along the optical port-cavity 480 until the end face 491 of the ferrule 490 is in contact with the ferrule-stop surface 460. As the ferrule 490 has a circular section, the ferrule 490 may roll when being moved leftwards along the optical port-cavity 480. As a result, it needs to arrange the ferrule 490 multiple times such that the end face 491 of the ferrule 490 is in contact with the ferrule-stop surface 460.

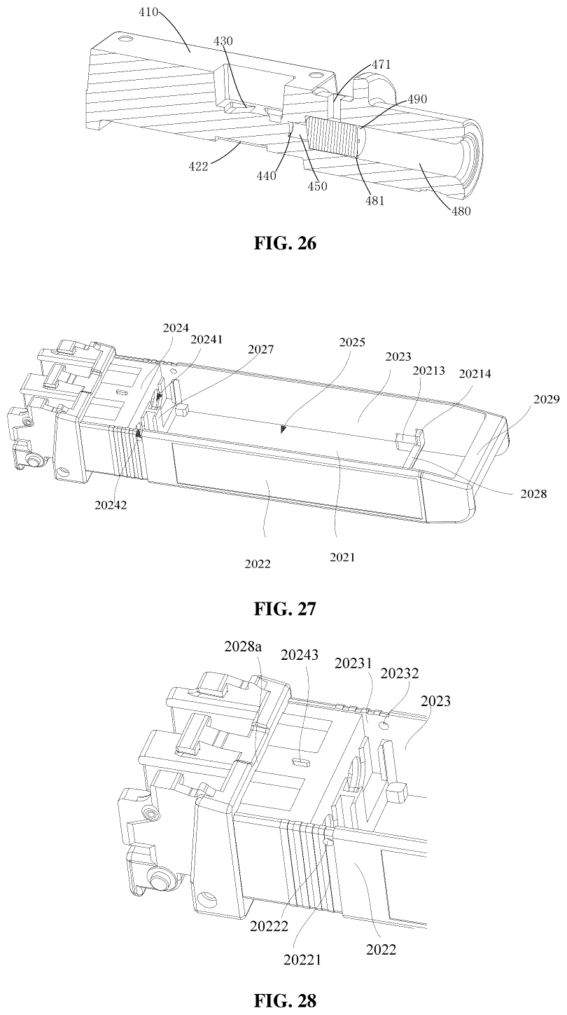

FIG. 24 is a sectional view of another first lens assembly according to some embodiments of this disclosure. FIG. 25 is a structural diagram of another ferrule according to some embodiments of this disclosure. FIG. 26 is a sectional assembly view of another first lens assembly and another ferrule according to some embodiments of this disclosure. As shown in FIG. 24, FIG. 25 and FIG. 26, to solve the foregoing problem, in some embodiments, a snapping step 481 is disposed in the optical port-cavity 480 of the lens body 410, and a snapping surface 494 is provided on the side wall of the ferrule 490. The snapping step 481 is disposed corresponding to the snapping surface 494. After the ferrule 490 is inserted into the opening of the optical port-cavity 480, the ferrule 490 is pushed to move into the optical port-cavity 480 by using a tweezers. When the ferrule 490 is pushed by using the tweezers, the ferrule 490 may rotate within the optical port-cavity 480 with relatively small rotation amplitude. When the tweezers stop pushing the ferrule 490, the snapping surface 494 of the ferrule 490 is engaged at the snapping step 481 of the optical port-cavity 480, thereby achieving close contact between the ferrule 490 and the ferrule-stop surface 460. After the ferrule 490 is in contact with the ferrule-stop surface 460, adhesive is injected into the optical port-cavity 480 through the dispensing slot 470, and the adhesive is applied on the outer surface of the ferrule 490, so as to fix the outer surface of the ferrule 490 with the inner side surface of the optical port-cavity 480 through the adhesive, thereby fixing the ferrule 490 inside the optical port-cavity 480.

In some embodiments, the snapping step 481 is located between the ferrule-stop surface 460 and a side of the optical port-cavity 480 that is away from the ferrule-stop surface 460, to ensure that an external circular ferrule inserted into the optical port-cavity 480 is attached to and connected with the optical port-cavity 480.

In some embodiments, a width of the snapping step 481 is smaller than that of the snapping surface 494, and a height of the snapping step 481 is smaller than a thickness of a cutoff portion of the ferrule 490 corresponding to the snapping surface 494, so as to facilitate assembly of the ferrule 490 and the optical port-cavity 480.

To fix the ferrule 490 in the optical port-cavity 480, in some embodiments, the snapping step 481 is disposed corresponding to the dispensing slot 470. Through the engagement between the snapping step 481 and the snapping surface 494 of the ferrule 490, a portion of the ferrule 490 is fixed in the optical port-cavity 480. Adhesive is injected into the optical port-cavity 480 through the dispensing slot 470, so as to fix the other portion of the ferrule 490 in the optical port-cavity 480.

In some embodiments, the snapping surface 494 is located at a high point of the end face of the ferrule 490; the dispensing slot 470 includes the second dispensing slot 472 only; and the opening of the second dispensing slot 472 faces downwards. Through the engagement between the snapping step 481 and the snapping surface 494 located at the high point of the end face of the ferrule 490, an upper portion of the ferrule 490 is fixed in the optical port-cavity 480. Adhesive is applied to a lower outer surface of the ferrule 490 through the second dispensing slot 472 with the opening facing downwards, so as to fix the lower portion of the ferrule inside the optical port-cavity 480 (that is, the lower portion of the ferrule is bonded to the inner side surface of the optical port-cavity 480).

In some embodiments, the snapping surface 494 is located at a low point of the end face of the ferrule 490; the dispensing slot 470 includes the first dispensing slot 471 only; and the opening of the first dispensing slot 471 faces upwards. Through the engagement connection between the snapping step 481 and the snapping surface 494 at the low point of the end face of the ferrule 490, a lower portion of the ferrule 490 is fixed in the optical port-cavity 480. Adhesive is applied to an upper outer surface of the ferrule 490 through the first dispensing slot 471 with the opening facing upwards, so as to fix the upper portion of the ferrule inside the optical port-cavity 480 (that is, it is bonded to the inner side surface of the optical port-cavity 480).

In addition to the foregoing contents, the other parts of the above first lens assemblies are identical, and thus will not be described herein in detail.

The above contents introduce the structure of the first lens assembly. To prevent the optical signal from returning along the original path to the optical emission chip at the other end of the external optical fiber, in some embodiments, specific design of an optical port-cavity of the second lens assembly is the same as that of an optical port-cavity of the first lens assembly.

In some embodiments, an optical module includes a circuit board and a lens assembly. An optical chip is disposed on the circuit board, and the lens assembly is covered on the optical chip. An inner surface of the lens assembly that faces towards the optical chip is provided with a first lens, and an outer surface of the lens assembly that faces away from the circuit board is provided with a reflective mirror. One end of the lens assembly is provided with an optical port-cavity. A second lens is disposed on an inner surface of the lens assembly that faces towards the optical port-cavity. A ferrule wrapping an optical fiber is disposed in the optical port-cavity. There is a gap between a fiber end-face and the second lens, and the fiber end-face is an inclined surface relative to a corresponding fiber side-face. Due to the gap between the fiber end-face and the second lens, an optical signal converged by the second lens is reflected on the fiber end-face, the reflected optical signal may be reflected to other places according to an angle of the fiber end-face, rather than returning along its original path, as the fiber end-face is an inclined surface relative to the corresponding fiber side-face. Thus, no interference may be caused to the optical chip. To limit a position of the ferrule in the lens assembly, one end of the optical port-cavity that faces towards the second lens is provided with a ferrule-stop surface. A through hole is disposed between the second lens and the ferrule-stop surface. An end face of the ferrule includes a step surface and a grinding surface, which have different angles. The ferrule-stop surface includes a first ferrule-stop portion and a second ferrule-stop portion. The first ferrule-stop portion is located above the through hole, and the second ferrule-stop portion is located below the through hole. A distance between the first ferrule-stop portion and an opening of the optical port-cavity is greater than a distance between the second ferrule-stop portion and the opening of the optical port-cavity, such that the second ferrule-stop portion is in contact with the grinding surface while the first ferrule-stop portion is not in contact with the step surface. Thus, the size of the step on the end face of the ferrule will not affect a distance between a vertex of the second lens and the fiber end-face, which ensures that a distance between the fiber end-face and the second lens remains unchanged. In this case, an actual spot size of the fiber end-face remains the same, which improves consistency in specifications of the optical module. After being inserted into the optical port-cavity through the opening at one end of the optical port-cavity, the ferrule is moved leftwards along the optical port-cavity until the end face of the ferrule is in contact with the ferrule-stop surface. In some embodiments, the first ferrule-stop portion is located above the through hole, and the second ferrule-stop portion is located below the through hole. The distance between the first ferrule-stop portion and the opening of the optical port-cavity is greater than that between the second ferrule-stop portion and the opening of the optical port-cavity, such that the second ferrule-stop portion is in contact with the grinding surface while the first ferrule-stop portion is not in contact with the step surface, thereby ensuring that the distance between the fiber end-face and the second lens remains unchanged. In this case, the actual spot size of the fiber end-face remains the same, thereby improving the consistency in the specifications of the optical module.

In some examples, the ferrule may be connected to the internal optical fiber, which in turn may be optically connected to the external optical fiber through the optical fiber adapter.

In some examples, the ferrule may be connected to the external optical fiber.

In some examples, the lens assembly may be disposed on one side of the circuit board.

In some examples, the optical fiber adapter may be a part of the lens assembly. For example, the lens assembly may have an extended portion, which may be configured as the optical fiber adapter.

In some examples, the optical port-cavity may be disposed in the optical fiber adapter. After being connected to the external optical fiber, the ferrule may be inserted in the optical port-cavity of the optical fiber adapter.

To facilitate cooperation between the optical fiber adapter and the shell, in some examples of the embodiments of this disclosure, an optical port-baffle plate may be disposed on the lower shell part. The optical port-baffle plate cooperates with the optical fiber adapter to facilitate fixing of the optical fiber adapter.

A structure of the shell provided in some embodiments of this disclosure is described in detail below.

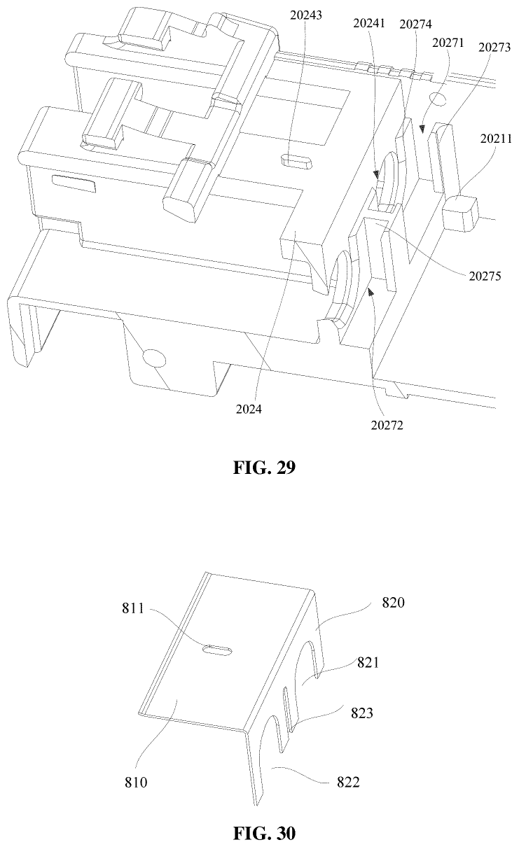

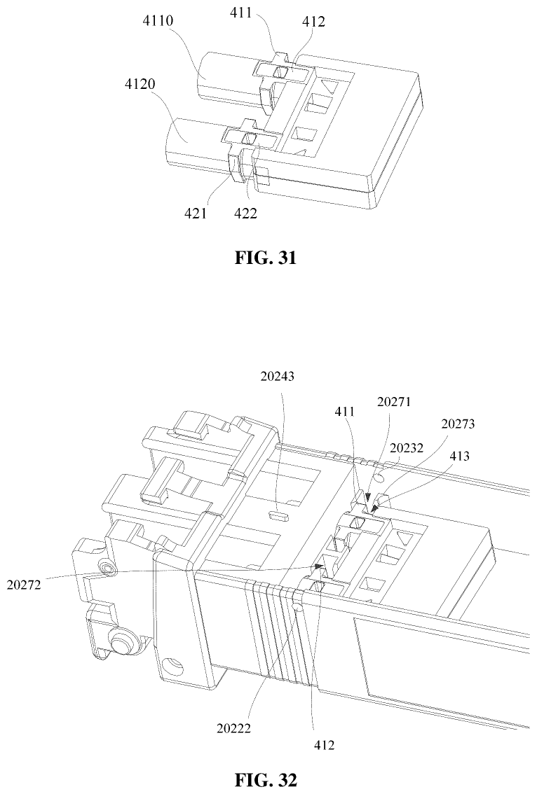

FIG. 27 is a first schematic structural diagram of a lower shell part according to some embodiments of this disclosure; FIG. 28 is a second schematic structural diagram of a lower shell part according to some embodiments of this disclosure; FIG. 29 is a first schematic structural diagram showing a section of a lower shell part according to some embodiments of this disclosure; FIG. 30 is a schematic structural diagram of a metal clamping member according to some embodiments of this disclosure; FIG. 31 is a schematic structural diagram of an optical transceiver component according to some embodiments of this disclosure. As shown in FIG. 27, FIG. 28 and FIG. 29, the lower shell part includes a bottom plate 2021, a first lower side plate 2022 disposed on one side of the bottom plate and a second lower side plate 2023 disposed on an opposite side of the first lower side plate 2022. The lower shell part is provided with an optical port-baffle plate 2024, which is located between the first lower side plate and the second lower side plate. Moreover, a bottom portion of the optical port-baffle plate 2024 is connected to the bottom plate. A semi-enclosing structure is enclosed by the optical port-baffle plate 2024, the first lower side plate, the second lower side plate and the bottom plate. The optical port-baffle plate 2024 divides the lower shell part into a first cavity and a second cavity. The upper shell part is covered above the first cavity 2025 to form an optical inner cavity.

The optical port-baffle plate 2024 is provided with a first matching through hole 20241 and a second matching through hole 20242.

Referring to FIG. 31, in some examples, the optical fiber adapter may include a first optical fiber adapter 4110 and a second optical fiber adapter 4120. One end of the first optical fiber adapter 4110 is extended to the second cavity through the first matching through hole 20241. The circuit board is located in the first cavity. One end of the second optical fiber adapter 4120 is extended to the second cavity through the second matching through hole 20242.

Each of the first and second matching through holes wraps an outer wall of the optical fiber adapter, and is of a circular through hole structure. Compared to a through hole formed by covering the upper shell part on the lower shell part, there are no gaps outside of the first and second matching through holes in this application, which reduces leakage of electromagnetic waves.

To facilitate fixed connection between the optical fiber adapter and the lower shell part, the optical fiber adapter is provided with a matching protrusion, which protrudes from an outer surface of the optical fiber adapter. One side of the optical port-baffle plate 2024 is provided with a matching-fixing portion 2027, in which the matching protrusion is snap fitted and fixed.

For example, the first optical fiber adapter 4110 is provided with a first matching protrusion 411, which protrudes from the outer surface of the first optical fiber adapter 4110. The second optical fiber adapter 4120 is provided with a second matching protrusion 421, which protrudes from the outer surface of the second optical fiber adapter 4120.

In some embodiments, the outer surface of the first optical fiber adapter 4110 is of a cylindrical shape, and the first matching protrusion 411 is of a cylindrical shape. Moreover, the first matching protrusion 411 is concentrically disposed with the first optical fiber adapter 4110. The outer surface of the second optical fiber adapter 4120 is of a cylindrical shape, the second matching protrusion 421 is of a cylindrical shape, and the second matching protrusion 421 is concentrically disposed with the second optical fiber adapter 4120.

The matching-fixing portion 2027 is located in the first cavity, and an upper surface of the matching-fixing portion is lower than that of the optical port-baffle plate 2024. The matching-fixing portion 2027 has a matching groove with an opening facing towards the upper shell part. For example, the matching-fixing portion 2027 has a first matching groove 20271 and a second matching groove 20272. The first matching protrusion 411 is embedded in the first matching groove 20271, and the second matching protrusion 421 is embedded in the second matching groove 20272.

A first limiting protrusion 20243 is disposed on the upper surface of the optical port-baffle plate 2024, and an upper surface of the first limiting protrusion 20243 is protruded relative to the upper surface of the optical port-baffle plate 2024.

A first check portion 20273 and a second check portion 20274 are disposed on two sides of the first matching groove 20271. The first matching groove limits a position of the first matching protrusion, and the first matching protrusion is located between the first check portion 20273 and the second check portion 20274. An isolation portion 20275 is disposed between the first matching groove 20271 and the second matching groove 20272.

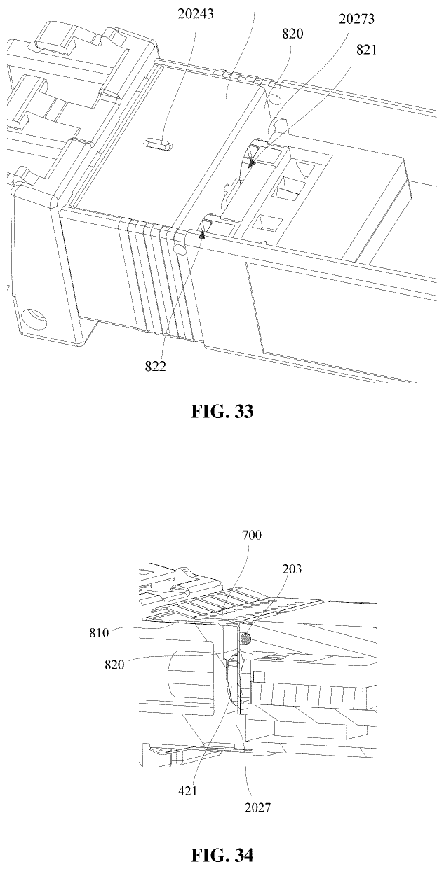

FIG. 32 is a schematic diagram showing a connection between an optical transceiver component and a lower shell part according to some embodiments of this disclosure; FIG. 33 is a schematic diagram showing a connection between an optical transceiver component, a metal clamping member and a lower shell part according to some embodiments of this disclosure; and FIG. 34 is a schematic sectional view of a metal clamping member, a lower shell part and an optical transceiver component according to some embodiments of this disclosure.

Referring to FIG. 30 to FIG. 33, in some examples, the optical module is also provided with a metal clamping member 800, which is connected to the lower shell part 202. An upper surface of the metal clamping member is in contact with and connected to inner surface of a cover plate, such that the metal clamping member is located in a gap between the upper shell part and the lower shell part, thereby shielding electromagnetic waves between the cage and the shell, and preventing external electromagnetic waves from entering the optical module.

In some examples, the metal clamping member 800 is in contact with and connected to the upper surface of the matching-fixing portion 2027, to block a gap between the matching-fixing portion 2027 and the upper shell part.

As shown in FIG. 30 and FIG. 31, the metal clamping member 800 includes a first clamping board 810 and a second clamping board 820 that are disposed to be bent relative to each other. The first clamping board 810 is provided with a limiting hole 811, into which the first limiting protrusion 20243 is embedded to limit the position of the metal clamping member 800, thereby preventing the metal clamping member 800 from moving along a length direction and a width direction of the optical module. The second clamping board 820 is provided with a first avoidance portion 821, a second avoidance portion 822 and a third avoidance portion 823. The first avoidance portion 821 is located in the first matching groove 20271 and is clamped and fixed outside the first matching protrusion. The second avoidance portion 822 is located in the second matching groove 20272 and is clamped and fixed outside the second matching protrusion. The third avoidance portion 823 is located between the first avoidance portion 821 and the second avoidance portion 822. The isolation portion 20275 is embedded in the third avoidance portion 823. The second clamping board 820 of the metal clamping member 800 blocks a gap between the optical fiber adapter and the matching groove, so as to prevent the electromagnetic waves from leaking from a position of the optical port, thereby improving an electromagnetic shielding effect of the optical module.

For example, a first side wall of the upper shell part is connected to the other side of the matching protrusion. For example, the second clamping board is located between the matching protrusion and the first side wall of the upper shell part, which is beneficial for improving the electromagnetic shielding effect at the optical port.

The first clamping board is located above the optical port-baffle plate 2024. A surface of the optical port-baffle plate 2024 is of a planar structure, facilitating mounting and fixing of the first clamping board. The first limiting protrusion 20243 is embedded in the limiting hole 811 to limit the metal clamping member 800 and the optical port-baffle plate 2024, thereby preventing the metal clamping member 800 and the optical port-baffle plate 2024 from moving along the length direction and the width direction of the optical module. An elastic part 700 is elastically pressed on an upper surface of metal clamping member 800.

To mount the metal clamping member 800, the upper surface of the matching-fixing portion 2027 is lower than the upper surface of the optical port-baffle plate 2024; a lower surface of the first clamping board 810 of the metal clamping member 800 is connected with the upper surface of the matching-fixing portion 2027, and an upper surface of the first clamping board 810 is connected to the upper shell part.

For example, the first optical fiber adapter 4110 is provided with the first matching protrusion 411, which is protruded relative to the outer surface of the first optical fiber adapter 4110. The second optical fiber adapter 4120 is provided with the second matching protrusion 421, which is protruded relative to the outer surface of the second optical fiber adapter 4120.

In some embodiments, the outer surface of the first optical fiber adapter 4110 is of a cylindrical shape, and the first matching protrusion 411 is of a cylindrical shape. Moreover, the first matching protrusion 411 is concentrically disposed with the first optical fiber adapter 4110. The outer surface of the second optical fiber adapter 4120 is of a cylindrical shape, and the second matching protrusion 421 is of a cylindrical shape. Moreover, the second matching protrusion 421 is concentrically disposed with the second optical fiber adapter 4120.

The matching-fixing portion 2027 is located in the first cavity, and the upper surface of the matching-fixing portion is lower than that of the optical port-baffle plate 2024. The matching-fixing portion 2027 has the matching groove with an opening facing towards the upper shell part. For example, the matching-fixing portion 2027 has the first matching groove 20271 and the second matching groove 20272. The first matching protrusion 411 is embedded in the first matching groove 20271, and the second matching protrusion 421 is embedded in the second matching groove 20272.

Referring to FIG. 32, in some embodiments, a matching slot is formed between the matching protrusion and the lens assembly, and the check portion is embedded in the matching slot. For example, a first matching slot 413 is formed between the first matching protrusion and the lens assembly. The first check portion 20273 is embedded in the first matching slot to limit the optical transceiver component.

As shown in FIG. 32, FIG. 33 and FIG. 34, one end of the first optical fiber adapter 4110 is extended to the first matching groove 20271 through the first avoidance portion, passed through the first matching through hole, and then into the first cavity. At this time, the first matching protrusion 411 is embedded in the first matching groove 20271, and the second clamping board is located in the first matching groove 20271 between the first matching protrusion 411 and the first check portion.

The first limiting protrusion 20243 is disposed on the upper surface of the optical port-baffle plate 2024. The upper surface of the first limiting protrusion 20243 is protruded relative to the upper surface of the optical port-baffle plate 2024. The first limiting protrusion 20243 is embedded in the limiting hole 811 to limit the metal clamping member 800.

In the embodiments of this disclosure, the optical port-baffle plate is disposed at a position of the optical port of the lower shell part. It is only at the matching through holes that there is a channel communicating with an exterior of the optical port along the length direction of the optical port-baffle plate, and thus electromagnetic leakage may only occur at the matching through holes. The optical fiber adapter blocks the matching through holes, and especially completely blocks the matching through holes if a diameter of the matching protrusion is greater than that of the matching through hole. The second clamping board of the metal clamping member forms an electromagnetic shielding between the matching protrusion and the matching groove in a direction towards the optical port, thereby improving the electromagnetic shielding effect of the optical module. The upper shell part is located at one side of the second clamping board, and the second clamping board functions to limit the upper shell part in the length direction.

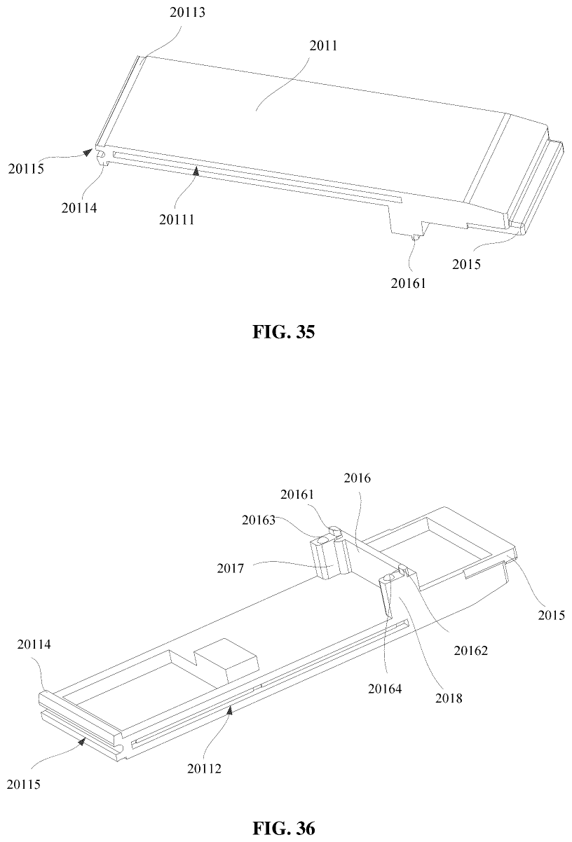

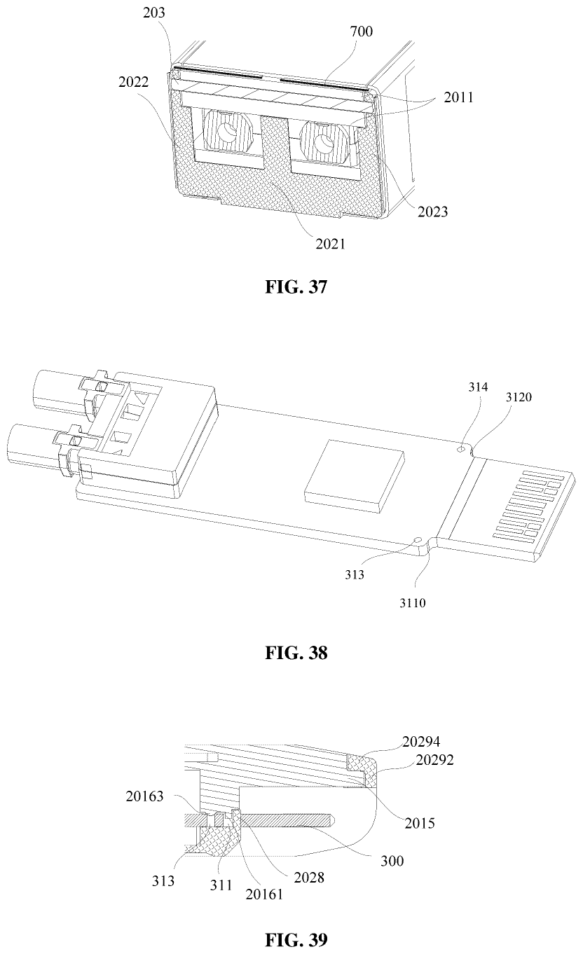

FIG. 35 is a first schematic structural diagram of an upper shell part according to some embodiments of this disclosure. FIG. 36 is a second schematic structural diagram of an upper shell part according to some embodiments of this disclosure. FIG. 37 is a schematic sectional view of an upper shell part and a lower shell part according to some embodiments of this disclosure. As shown in FIG. 28, FIG. 35, FIG. 36 and FIG. 37, to achieve connection between the upper shell part and the lower shell part, the first lower side plate 2022 is provided with a first elastic clamping slot 20221, which is recessed inwards relative to the first lower side plate. The second lower side plate 2023 is provided with a second elastic clamping slot 20231, which is recessed inwards relative to the second lower side plate.

The first elastic clamping slot 20221 is provided with a first limiting through hole 20222, and the second elastic clamping slot 20231 is provided with a second limiting through hole 20232. The first side wall of the upper shell part is provided with a limiting slot 20115. A positioning rod 203 extends into the limiting slot 20115 through the first limiting through hole 20222, and then enters the second limiting through hole 20232. The positioning rod 203 connects the upper shell part to the lower shell part.

In some embodiments of this disclosure, the first side wall of the upper shell part is a side wall facing towards the optical port, and an opening of the limiting slot 20115 faces towards the optical port. Referring to FIG. 28, the lower shell part is further provided with a limiting baffle plate 2028a. An upper surface of the limiting baffle plate 2028a is protruded relative to that of the optical port-baffle plate 2024. The first side wall of the upper shell part abuts against one side of the limiting baffle plate 2028a, and a lower surface of the upper shell part is connected to the optical transceiver component, such that the metal clamping member 800 is in contact with and connected to the optical port-baffle plate 2024.

In some embodiments of this disclosure, an upper surface of the upper shell part is provided with a first concave region 20113, which is lower than an upper surface of the cover plate 2011. Two sides of the first concave region 20113 are higher than a bottom portion of the first concave region 20113, and an elastic piece of the elastic part 700 is embedded in the first concave region 20113. The two sides of the first concave region 20113 limit the elastic piece of the elastic part 700, thereby achieving mounting and fixing of the elastic part on the upper shell part.

Referring to FIG. 31, to achieve positioning of the optical transceiver component, an upper surface of the first optical fiber adapter 4110 is a first step surface 412, which is planar and is connected to the upper shell part. An upper surface of the second optical fiber adapter 4120 is a second step surface 422, which is planar and is connected to the upper shell part.

A lower surface of the cover plate 2011 is protruded downwards to form an abutting portion 20114. A lower surface of the abutting portion 20114 is protruded relative to the lower surface of the cover plate 2011, and is connected to the first step surface 412 and the second step surface.

A second side wall of the cover plate 2011 is provided with a first shielding concave region 20111, and an opening of the first shielding concave region 20111 faces towards the first lower side plate 2022. A first shielding part is disposed in a gap formed by the first shielding concave region 20111 and the first lower side plate 2022. For example, the first shielding part is a flexible part, and is filled in the gap formed by the first shielding concave region 20111 and the first lower side plate 2022, thereby improving shielding effect of the optical module. A second shielding concave region 20112 is provided on the third side wall of the cover plate 2011. A second shielding part is disposed in a gap formed by the second shielding concave region 20112 and the second lower side plate 2023. For example, the second shielding part is a flexible part, and is filled in the gap formed by the second shielding concave region 20112 and the second lower side plate 2023, thereby improving the shielding effect of the optical module.

The lower surface of the cover plate 2011 is provided with a first shielding baffle plate 2016, and a lower surface of the first shielding baffle plate 2016 is connected to the upper surface of the circuit board 300. Referring to FIG. 29, the lower shell part has a first supporting portion 20211, which is located at an adjacent side of the first check portion 20273. An upper surface of the first supporting portion 20211 is lower than an upper surface of the first check portion 20273. The circuit board is located above the first supporting portion 20211. The first shielding baffle plate 2016 runs through a width direction of the upper shell part.

The lower shell part has a second supporting portion, which is located opposite to the first supporting portion 20211 (not shown in the figures). An upper surface of the second supporting portion is lower than that of the first check portion 20273. The circuit board is located above the second supporting portion. The first supporting portion and the second supporting portion support a head portion of the circuit board 300. The head portion of the circuit board 300 is a portion of the circuit board that is adjacent to the optical port, and a tail portion of the circuit board is a portion of the circuit board that is adjacent to the electrical port.

One side of the circuit board 300 abuts against one side of the matching-fixing portion 2027, and the matching-fixing portion 2027 restricts movement of the circuit board along a length direction thereof. The optical transceiver component is located between the circuit board and the upper shell part, and imposes restrictions on movement of the circuit board along a height direction thereof. In this example, the circuit board and the shell are not fixed by using screws, such that space of the circuit board is reduced and miniaturization settings for the optical module are improved.

In some examples, the length direction is a direction of a connection line between the optical port and the electrical port, the width direction is a direction perpendicular to the first lower side plate, and the height direction is a direction perpendicular to the bottom plate.

Referring to FIG. 27, the bottom plate of the lower shell part is provided with a third supporting portion 20213, and the circuit board 300 is located on the third supporting portion 20213. One side of the third supporting portion 20213 is provided with a first shell-baffle plate 20214. An upper surface of the first shell-baffle plate 20214 is higher than that of the third supporting portion 20213, and is lower than an upper surface of the second lower side plate.

The bottom plate of the lower shell part is provided with a fifth supporting portion, and the circuit board 300 is located above the fifth supporting portion. One side of the fifth supporting portion is provided with a second shell-baffle plate. An upper surface of the second shell-baffle plate is higher than that of the fifth supporting portion, and is lower than that of the first lower side plate.

FIG. 38 is a schematic structural diagram of a circuit board and an optical transceiver component according to some embodiments of this disclosure. As shown in FIG. 38, the circuit board 300 is provided with a first corner 3110 and a second corner 3120. For example, the first corner 3110 is adjacent to the first lower side plate 2022, and the second corner 3120 is adjacent to the second lower side plate 2023.

Two ends of the first shielding baffle plate 2016 is extended towards the optical port to form a second shielding baffle plate 2017 and a third shielding baffle plate 2018. The second shielding baffle plate 2017 is adjacent to the first lower side plate, and the third shielding baffle plate is adjacent to the second lower side plate. A lower surface of the second shielding baffle plate 2017 is provided with a first circuit-baffle plate 20161 and a second limiting protrusion 20163. The first circuit-baffle plate 20161 is perpendicular to the cover plate, and extends towards the second lower side plate. The first circuit-baffle plate 20161 extends into a gap between the first corner 3110 and the first shell-baffle plate 20214. The first corner 3110 and the first shell-baffle plate 20214 limit the first circuit-baffle plate 20161 in the length direction.

One side of the first circuit-baffle plate 20161 is connected to the first corner 3110, and the other side thereof abuts against a side wall of the first shell-baffle plate 20214.

The circuit board 300 is further provided with a third limiting hole 313 and a fourth limiting hole 314. The third limiting hole 313 is adjacent to the first lower side plate, and the fourth limiting hole 314 is adjacent to the second lower side plate. One end of the second limiting protrusion 20163 is embedded in the third limiting hole 313, and the second limiting protrusion 20163 is fitted with the third limiting hole 313. In some examples, the third limiting hole 313 is of a circular hole, and the second limiting protrusion 20163 is a cylindrical or a spherical protrusion that matches with the third limiting hole 313.

A lower surface of the third shielding baffle plate 2018 is provided with a second circuit-baffle plate 20162 and a third limiting protrusion 20164. The second circuit-baffle plate 20162 is perpendicular to the cover plate, and extends towards the first lower side plate. The second circuit-baffle plate 20162 extends into a gap between the second corner and the second shell-baffle plate. The second corner 3120 and the second shell-baffle plate limit the second circuit-baffle plate 20162 in the length direction. One end of the third limiting protrusion 20164 is embedded in the fourth limiting hole 314, and the third limiting protrusion 20164 is fitted with the fourth limiting hole 314. In some examples, the fourth limiting hole 314 has a circular structure, and the third limiting protrusion 20164 is a cylindrical or a spherical protrusion that matches with the fourth limiting hole 314. The fourth limiting hole 314 may also be of a square structure. In this case, the third limiting protrusion 20164 has a shape that matches with the fourth limiting hole 314.

To further improve the electromagnetic shielding effect of the optical module, metal layers are coated inside the third limiting hole 313 and the fourth limiting hole 314, and one end of the second limiting protrusion 20163 is embedded in the third limiting hole 313, such that the circuit board is connected to the upper shell part through the metal layers, thereby improving the electromagnetic shielding effect of the optical module.

Surfaces of the first corner 3110 and the second corner 3120 are provided with metal layers, which are connected to the first circuit-baffle plate 20161 and the second circuit-baffle plate 20162, thereby improving the electromagnetic shielding effect of the optical module.

Referring to FIG. 27, the lower shell part is further provided with a second electrical port-baffle plate 2028. The second electrical port-baffle plate 2028 is protruded above the bottom plate, and the circuit board is located above the second electrical port-baffle plate. A position of the second electrical port-baffle plate 2028 corresponds to that of the first shielding baffle plate. The circuit board is located between the second electrical port-baffle plate 2028 and the first shielding baffle plate, to form an enclosure structure for the electrical port of the optical module, thereby preventing the electromagnetic waves of the optical module from overflowing through the electrical port. A projection of the first shielding baffle plate covers the second electrical port-baffle plate.

In this example, at a side adjacent to the optical port, the lower surface of the circuit board is located above the first supporting portion and the second supporting portion of the lower shell part; the upper surface of the circuit board 300 is connected to the optical transceiver component; and the optical transceiver component is in contact with and connected to the abutting portion 20114 of the cover plate, thereby achieving positioning of the circuit board. At a side adjacent to the electrical port, the circuit board is located above the third supporting portion and the fourth supporting portion; and the upper surface of the circuit board is connected to the first shielding baffle plate, the second shielding baffle plate and the third shielding baffle plate on the cover plate, so as to limit the circuit board through the third limiting hole and the second limiting protrusion as well as through the fourth limiting hole and the third limiting protrusion.

At the optical port of the optical module, the first side wall of the upper shell part is provided with the limiting slot 20115. The positioning rod 203 extends into the limiting slot 20115 through the first limiting through hole 20222, and then enters the second limiting through hole 20232. The positioning rod 203 connects the upper shell part 201 to the lower shell part 202. The positioning rod limits a connection relationship between the cover plate and the lower shell part. The lower shell part is further provided with the limiting baffle plate 2028a. The upper surface of the limiting baffle plate 2028a is protruded relative to that of the optical port-baffle plate 2024. The first side wall of the upper shell part abuts against one side of the metal clamping member 800, and the lower surface of the upper shell part is connected to the optical transceiver component, such that the metal clamping member 800 is in contact with and connected to the optical port-baffle plate 2024.

The elastic part 700 blocks the first limit through hole 20222 and the second limiting through hole 20232, which may prevent the positioning rod 203 from coming out through the first limiting through hole 20222 or the second limiting through hole 20232, thereby limiting the positioning rod 203.

One side of the circuit board, that is located at one side of a connection line between the limiting baffle plate 2028a and the first shielding baffle plate 2016, is provided with various optoelectronic devices, while there are no electrical devices on the other side of the circuit board that is located at the other side of the connection line between the limiting baffle plate 2028a and the first shielding baffle plate 2016. The optoelectronic devices are located in an enclosed space formed by covering the upper shell part with the lower shell part. The limiting baffle plate 2028a and the first shielding baffle plate 2016 seal the space in a direction of the electrical port, thereby avoiding leakage of the electromagnetic waves.

To facilitate connection between the golden finger and the master computer, a region where the golden finger is located is outside the enclosed space formed by covering the upper shell part with the lower shell part. To protect the golden finger, a protection plate 2029 is disposed on a tail portion of the lower shell part. The protection plate 2029 is located between the first lower side plate 2022 and the second lower side plate 2023, and is located above the circuit board.

FIG. 39 is a schematic diagram showing a local section of an optical module according to some embodiments of this disclosure. As shown in FIG. 39, one end of the cover plate 2011 is provided with a protection step surface 2015, and an upper surface of the protection step surface 2015 is lower than that of the cover plate. The upper surface of the protection step surface 2015 is connected to a lower surface of the protection plate 2029. The protection plate 2029 is in contact with and connected to the protection step surface 2015. A side wall of the protection plate 2029 abuts against that of the cover plate. The protection plate 2029 and the positioning rod 203 limits a position of the cover plate in the length direction, achieving connection between the upper shell part and the lower shell part.

The protection plate 2029 includes a first baffle plate 20294 and a second baffle plate 20292. The first baffle plate is located above the protection step surface 2015, and limits a position of a tail portion of the upper shell part in an up-down structure. The second baffle plate 20292 is perpendicular to the first baffle plate, and is located outside of the protection step surface 2015. The protection step surface 2015 abuts against a side wall of the second baffle plate, such that the second baffle plate positions the upper shell part in the length direction.

The second side wall of the cover plate 2011 is in contact with and connected to the first lower side plate of the lower shell part, and a third side wall of the cover plate 2011 is in contact with and connected to the second lower side plate of the lower shell part. To prevent the electromagnetic waves from overflowing from a gap between the second side wall of the cover plate 2011 and the lower shell part, the second side wall of the cover plate 2011 is provided with the first shielding concave region 20111, in which the first shielding part is filled. A projection of the first shielding concave region 20111 on the circuit board runs through a length direction of a first circuit region. To prevent the electromagnetic waves from overflowing from a gap between the third side wall of the cover plate 2011 and the lower shell part, the third side wall of the cover plate 2011 is provided with the second shielding concave region 20112, in which the second shielding part is filled. A projection of the second shielding concave region 20112 on the circuit board runs through the length direction of the first circuit region.

The unlocking part includes a rotating member, a sliding member, a pull ring and a rotating shaft; and the unlocking part is connected to the lower shell part. In this example, the rotating member, the sliding member and the rotating shaft of the unlocking part are located on the bottom plate, and the unlocking part is not in contact with the upper shell part.

In some embodiments, the upper shell part is of a plate-like structure, and does not include any upper side plate perpendicular to the cover plate. The cover plate 2011 is entirely embedded between the first lower side plate 2022 and the second lower side plate 2023 of the lower shell part. The upper surface of the cover plate 2011 flushes with that of the first lower side plate 2022.

In some embodiments of this disclosure, the upper shell part and the lower shell part are connected via the positioning rod, and there is no need for a screw to pass through the upper shell part and the lower shell part, bringing in a simple structure and facilitating mounting. At the same time, the optical port-baffle plate divides the shell into a first cavity and a second cavity, and the matching through hole communicates the first cavity with the second cavity, thereby achieving positioning and mounting of the optical fiber adapter. In this way, the position of the optical port is blocked, thereby improving the electromagnetic shielding effect of the optical module. The circuit board is fixedly connected to the upper shell part and the lower shell part in a press-fitting manner, which reduces space occupied by the screw, and is beneficial for improving the miniaturization of the optical module.

In some examples, to drive the optical emission chip, an optical emission chip-driving chip may be disposed on the circuit board. Peripheral power supply and control circuit of the current optical emission chip-driving chip is complex, and PCB layout occupies a large area. At the same time, the current optical emission chip-driving chip has limited functions and high costs, which is not conducive to reducing space occupancy rate of the optical module and is not conducive to cost control. In view of this, in some embodiments of this disclosure, a logic circuit is deployed on the circuit board, and on and off of the optical emission chip in both hardware and software layers of the master computer are implemented through the logic circuit. A specific structure of the circuit board in the optical module provided in some embodiments of this disclosure is described in detail below.

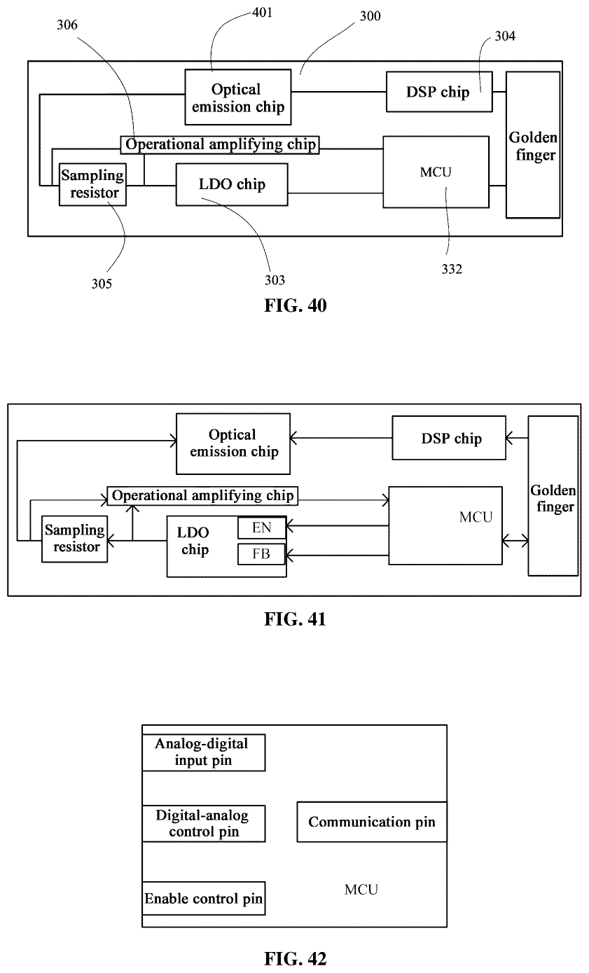

FIG. 40 is a partial schematic structural diagram of an optical module according to some embodiments of this disclosure. FIG. 41 is a schematic diagram showing partial signal flow of an optical module according to some embodiments of this application. As shown in FIG. 40 and FIG. 41, to solve the foregoing problem, this disclosure provides an optical module, wherein one end of a circuit board of the optical module is provided with a golden finger and is connected to a master computer, for receiving an electrical signal from the master computer. An MCU 332 is disposed on the circuit board and is connected to the golden finger, so as to receive an electrical signal from the master computer and process the electrical signal so as to control an LDO chip.

The LDO chip is connected to the MCU 332, for receiving a control signal from the MCU 332. The MCU 332 outputs a signal to the LDO chip to control on and off of the LDO chip. The LDO chip is connected to an optical emission chip 401, and outputs a bias signal to drive the optical emission chip 401.

A DSP chip 304 is electrically connected to the golden finger for receiving a control signal from the master computer. The DSP chip is connected to the optical emission chip 401, and outputs a modulation signal to the optical emission chip 401.

One end of the LDO chip is connected to the optical emission chip, and outputs a direct current-drive signal to the optical emission chip. One end of the DSP chip is connected to the optical emission chip 401, and outputs an alternate current-load signal to the optical emission chip.

The LDO chip 303 receives the control signal from the MCU 332, and outputs a bias signal to the optical emission chip to drive the optical emission chip 401. The DSP chip outputs a modulation signal to the optical emission chip 401, and performs amplitude modulation on the optical emission chip 401. There is no complex, integrated or expensive optical emission chip-driving chip in this disclosure. The optical emission chip 401 is directly driven through the LDO chip. The circuit design is simplified by replacing an integrated optical emission chip-driving chip with an independently designed LDO chip, based on existing optical module hardware, which also reduces module costs, and eliminates dependence on the optical emission chip-driving chip.

In some embodiments, the circuit board is also provided with a sampling resistor 305 and an operational amplifying chip 306. The sampling resistor is disposed between the LDO chip and the optical emission chip, to collect a magnitude of the bias current from the LDO chip to the optical emission chip. A first input of the operational amplifying chip 306 is connected to a first end of the sampling resistor, a second input end of the operational amplifying chip 306 is connected to a second end of the sampling resistor, and an output end of the operational amplifying chip 306 is connected to the MCU. The operational amplifying chip 306 collects an analog voltage difference between two ends of the sampling resistor, and transmits the analog voltage difference to the MCU. The MCU receives the analog voltage difference and converts the same into a bias current value. The master computer is in a communication connection to the MCU through the golden finger, reads the bias current value in the MCU, and completes reporting of the bias current value.

In some embodiments, the golden finger is connected to the MCU through an IIC communication bus, thereby achieving a communication connection between the golden finger and the MCU.

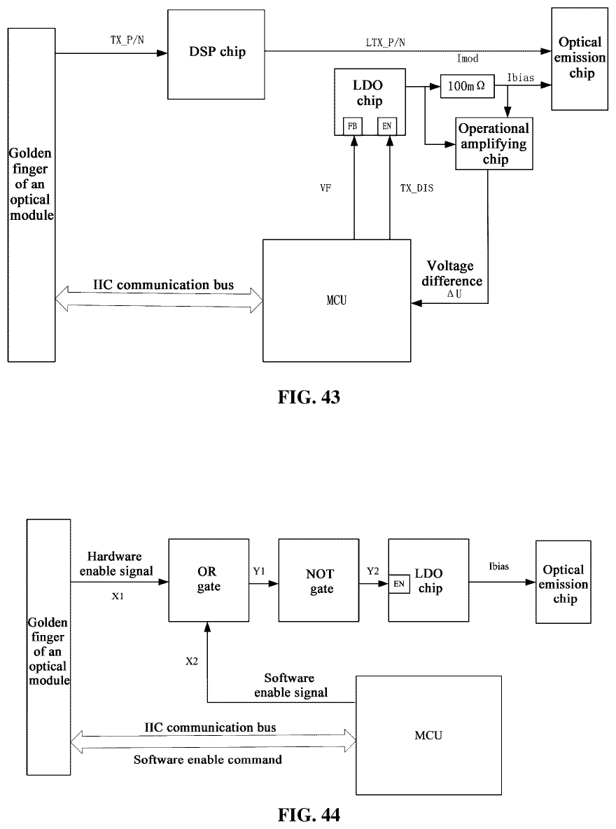

FIG. 42 is a schematic structural diagram of an MCU according to some embodiments of this disclosure. FIG. 43 is a schematic diagram showing a signal flow of an optical module according to some embodiments of this disclosure. As shown in FIG. 42 and FIG. 43, the MCU has an enable control pin, which is connected to an EN enable pin of the LDO chip. The MCU controls on and off of the LDO chip through the enable control pin.

For example, the enable control pin is a GPIO port, the LDO chip is turned on when a signal output from the enable control pin is at high voltage, and is turned off when the signal output from the enable control pin is at low voltage.

The MCU has a digital-analog control pin, which is connected to an FB adjustment pin of the LDO chip. The MCU outputs a signal through the digital-analog control pin to control the FB adjustment pin, so as to control magnitude of a current output from the LDO chip.

The LDO chip is disposed on the circuit board. The FB adjustment pin and the EN enable pin of the LDO chip are connected to the MCU 332. An output end of the LDO chip is connected to the optical emission chip to directly drive the optical emission chip 401, thereby reducing configuration of the commonly used laser driver chip and relevant matching circuits for the laser driver chip, which is beneficial for reducing space occupied by the circuit board and improving module integration.

In the embodiments of this application, under control of the MCU, the LDO chip outputs different bias currents to drive the optical emission chip, so as to keep the optical emission chip on and operate stably.

In some embodiments, the sampling resistor is 100 mΩ.

In some embodiments, the DSP chip outputs an alternate current-load signal, which is loaded onto the optical emission chip together with the driving signal output by the LDO chip.

To further reduce signal disturbance, a first filtering network is disposed at the output end of the LDO chip, so as to prevent an alternate current signal from passing in a reverse direction. The first filtering network is an RL filtering network, that is, an alternate current filtering network mainly built with resistors and inductors or beads. A main function of the first filtering network is to allow a direct current-bias current to pass in a forward direction, thereby preventing the alternate current signal from passing in a reverse direction, otherwise, it would interfere with normal operation of the DC signal.

The sampling resistor 305 and the operational amplifying chip 306 are disposed between the LDO chip and the optical emission chip. The sampling resistor is disposed between the LDO chip and the optical emission chip to collect magnitude of bias current flowing from the LDO chip to the optical emission chip. The first input of the operational amplifying chip 306 is connected to the first end of the sampling resistor, the second input end of the operational amplifying chip 306 is connected to the second end of the sampling resistor, and the output end of the operational amplifying chip 306 is connected to the MCU. The operational amplifying chip 306 collects an analog voltage difference between two ends of the sampling resistor, and transmits the analog voltage difference to the MCU. The MCU receives the analog voltage difference and converts the same into a bias current value. The master computer is in a communication connection to the MCU through the golden finger, reads the bias current value in the MCU, and completes reporting of the bias current value.

In some embodiments of this application, the LDO chip is connected to the MCU, and on and off of the optical emission chip is controlled through the EN enable pin of the LDO chip. The FB adjustment pin of the LDO is controlled through the digital-analog control pin of the MCU, so that output voltage of the LDO is adjusted, thereby implementing a function of adjusting the bias current of a laser. By combining the sampling resistor with the operational amplifying chip, the bias current of the optical emission chip is collected, thereby implementing functions of monitoring and reporting the bias current of the optical emission chip.

In some embodiments of this application, a DCDC power chip may also be provided to replace the LDO chip. The DCDC power chip is a laser bias circuit. The MCU is provided with enable pins, and is connected to the DCDC chip for achieving on and off of the DCDC chip. The DCDC chip is also connected to a power circuit, which provides input voltage to the DCDC chip.

In some embodiments of this application, circuits such as an IDAC chip or an operational amplifier may also be used, to be connected to control pins of the MCU. Different driving voltages are output to the optical chip of the optical emission chip according to a magnitude of a control voltage of the MCU.

In some embodiments, the optical module is also provided with a temperature detector. The temperature detector is configured to detect ambient temperature of the optical emission chip, and control a magnitude of a control voltage output to the LDO chip based on the ambient temperature of the optical emission chip. An algorithm for a temperature-and-voltage relationship is built in the MCU, such that the magnitude of the output voltage is calculated based on the received temperature.

A circuit of the optical emission chip is driven through the laser driver chip. To achieve control of the on and off of the optical emission chip by the master computer, a hardware enable signal sent by the master computer is directly sent to the laser driver chip, so as to achieve the control of the on and off of the optical emission chip. The hardware enable signal may also be sent to the MCU for monitoring a status of a host hardware enable signal. The master computer sends a software enable signal to the MCU of the optical module through an IIC bus. After receiving a software enable signal command, the MCU issues an optical command for turning on or off the laser driver chip through the IIC bus between the MCU and the laser driver chip, thereby implementing a software enable function of the optical module.

In some embodiments, the optical module includes the MCU, the logic circuit, the LDO chip and the optical emission chip. The MCU is in a communication to the golden finger, and receives a software enable control command from the master computer. The enable control pin of the MCU is connected to a first input end of the logic circuit, and a second input end of the logic circuit is connected to the golden finger. An output end of the logic circuit is connected to the EN enable pin of the LDO chip. The hardware enable signal of the master computer is used as a second input signal of the logic circuit, and the software enable signal of the optical module is used as a second input signal of the logic circuit. The output signal of the logic circuit is sent to the EN enable pin of the LDO chip for controlling on and off of the LDO, thereby achieving complete enabling and control for the on and off of the optical emission chip via hardware and software of the master computer. In the control circuit provided in this application, the hardware enable signal sent by the golden finger to the logic circuit is at a low level. When the software enable signal sent by the MCU to the logic circuit is at a low level, output of the logic circuit is at a high level, thereby controlling the optical emission chip to emit light.

In some embodiments, the logic circuit includes an OR gate logic circuit and a NOT gate logic circuit.

FIG. 44 is a second partial structural diagram of an optical module according to some embodiments of this disclosure. For an optical module without a laser driver chip, in order to achieve optical control for the on and off of the optical emission chip by the master computer, as shown in FIG. 44, the circuit board is provided with an OR gate logic circuit and a NOT gate logic circuit. The enable control pin of the MCU is connected to a first input end of the OR gate logic circuit, and a second input end of the OR gate logic circuit is connected to the golden finger. An output end of the OR gate logic circuit is connected to an input end of the NOT gate logic circuit. An output end of the NOT gate logic circuit is connected to the EN enable pin of the LDO chip. The hardware enable signal of the master computer is used as an input signal X1 of the OR gate, and the software enable signal of the optical module is used as an input signal X2 of the OR gate. An output signal Y1 of the OR gate is used as an input signal of the NOT gate. An output signal Y2 of the NOT gate is sent to the EN enable pin of the LDO chip for controlling the on and off of the LDO, thereby achieving complete hardware and software enabling and control for the on and off of the optical emission chip via the master computer.

Table 1 is a control logic table provided according to the structure shown in FIG. 44. As shown in Table 1, the hardware enable signal sent by the golden finger to the OR gate logic circuit is at a low level. When the software enable signal sent by the MCU to the OR gate logic circuit is at a low level, output of the OR gate logic circuit is at a low level, and output of the NOT gate logic circuit is at a high level, thereby controlling the optical emission chip to emit light.

The hardware enable signal sent by the golden finger to the OR gate logic circuit is at a low level. When the software enable signal sent by the MCU to the OR gate logic circuit is at a high level, the output of the OR gate logic circuit is at a high level, while the output of the NOT gate logic circuit is at a low level, thereby controlling the optical emission chip not to emit light.

The hardware enable signal sent by the golden finger to the OR gate logic circuit is at a high level. When the software enable signal sent by the MCU to the OR gate logic circuit is at a low level, the output of the OR gate logic circuit is at a high level, while the output of the NOT gate logic circuit is at a low level, thereby controlling the optical emission chip not to emit light.

The hardware enable signal sent by the golden finger to the OR gate logic circuit is at a high level. When the software enable signal sent by the MCU to the OR gate logic circuit is at a high level, the output of the OR gate logic circuit is at a high level, while the output of the NOT gate logic circuit is at a low level, thereby controlling the optical emission chip not to emit light.

The optical module provided in this disclosure includes the MCU, the OR gate logic circuit, the NOT gate logic circuit, the LDO chip and the optical emission chip. The MCU is in a communication connection to the golden finger, and receives the software enable control command from the master computer. The enable control pin of the MCU is connected to the first input end of the OR gate logic circuit, and the second input end of the OR gate logic circuit is connected to the golden finger. The output end of the OR gate logic circuit is connected to the input end of the NOT gate logic circuit. The output end of the NOT gate logic circuit is connected to the EN enable pin of the LDO chip. The hardware enable signal of the master computer is used as an input signal of the OR gate, and the software enable signal of the optical module is used as an input signal of the OR gate. The output signal of the OR gate is used as the input signal of the NOT gate. The output signal of the NOT gate is sent to the EN enable pin of the LDO chip for controlling the on and off of the LDO, thereby achieving complete hardware and software enabling and control for the on and off of the optical emission chip via the master computer. In the control circuit provided in this application, the hardware enable signal sent by the golden finger to the OR gate logic circuit is at a low level. When the software enable signal sent by the MCU to the OR gate logic circuit is at a low level, the output of the OR gate logic circuit is at a low level, and the output of the NOT gate logic circuit is at a high level, thereby controlling the optical emission chip to emit light.

TABLE 1
Control Logic Table

| Hardware | Software | Output | Output | EN pin | Optical |
|---|---|---|---|---|---|
| enable | enable | Y1 of | Y2 of | status of | emission |
| signal X1 | signal X2 | OR gate | NOT gate | LDO | chip |
| Low | Low | Low | High | High | Emit light |
| Low | High | High | Low | Low | Not emit light |
| High | Low | High | Low | Low | Not emit light |
| High | High | High | Low | Low | Not emit light |

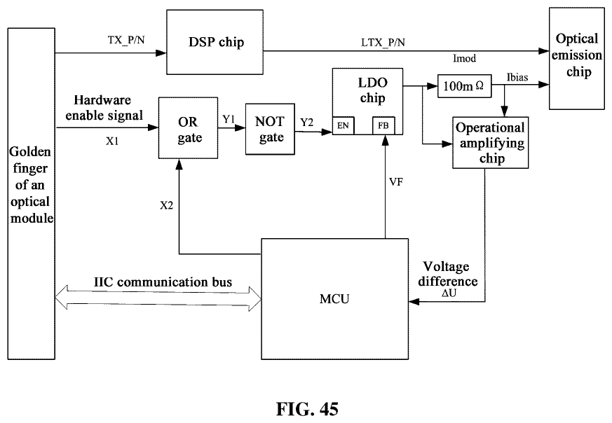

according to some embodiments of this disclosure. As shown in FIG. 45, the optical module is provided with the MCU, the DSP chip, the LDO chip and the optical emission chip. The MCU has an enable control pin. The enable control pin is connected to the first input end of the OR gate logic circuit, and the second input end of the OR gate logic circuit is connected to the golden finger. The output end of the OR gate logic circuit is connected to the input end of the NOT gate logic circuit. The output end of the NOT gate logic circuit is connected to the EN enable pin of the LDO chip, for controlling the on and off of the LDO, thereby achieving complete hardware and software enabling and control for the on and off of the optical emission chip via the master computer. In the control circuit provided in this application, the hardware enable signal sent by the golden finger to the OR gate logic circuit is at a low level. When the software enable signal sent by the MCU to the OR gate logic circuit is at a low level, the output of the OR gate logic circuit is at a low level, and the output of the NOT gate logic circuit is at a high level, and a bias signal is output, thereby controlling the optical emission chip to emit light.

The MCU has the digital-analog control pin, which is connected to the FB adjustment pin of the LDO chip. The MCU outputs a signal through the digital-analog control pin to control the FB adjustment pin, so as to control a magnitude of a current output from the LDO chip. The DSP chip is electrically connected to the golden finger for receiving the control signal from the master computer. The DSP chip is connected to the optical emission chip, and outputs a modulation signal to the optical emission chip, to perform signal modulation on light emitted from the optical emission chip. There are no complex, integrated or expensive optical emission chip-driving chips in this disclosure. The optical emission chip 401 is directly driven via the LDO chip. The circuit design is simplified by replacing an integrated optical emission chip-driving chip with an independently designed LDO chip based on existing optical module hardware, it also reduces module costs, and eliminates dependence on the optical emission chip-driving chip. At the same time, the OR gate logic circuit and the NOT gate logic circuit are simply combined with the MCU, thereby achieving complete hardware and software enabling and control for the on and off of the optical emission chip via the master computer.

In some embodiments, the sampling resistor and the operational amplifying chip are disposed between the LDO chip and the optical emission chip. The sampling resistor is disposed between the LDO chip and the optical emission chip, to collect a magnitude of bias current flowing from the LDO chip to the optical emission chip. The first input of the operational amplifying chip is connected to the first end of the sampling resistor, the second input end of the operational amplifying chip is connected to the second end of the sampling resistor, and the output end of the operational amplifying chip is connected to the MCU. The operational amplifying chip collects an analog voltage difference between two ends of the sampling resistor, and transmits the analog voltage difference to the MCU. The MCU receives the analog voltage difference and converts the same into a bias current value. The master computer is in a communication connection to the MCU through the golden finger, reads the bias current value in the MCU, and completes reporting of the bias current value.

Finally, it should be noted that the foregoing embodiments are merely intended to describe the technical solutions of this disclosure, and shall not be construed as limitation. Although this disclosure is described in detail with reference to the foregoing embodiments, one of ordinary skills in the art may understand that modifications still may be made to the technical solutions disclosed in the foregoing embodiments, or equivalent replacements may be made to some of the technical features. However, these modifications or equivalent replacements do not deviate the nature of corresponding technical solutions from the spirit and scope of the technical solutions of the embodiments of this disclosure.

What is claimed is:

1. An optical module, comprising:
a circuit board, on which an optical chip is disposed;
a lens assembly covered on the optical chip, wherein an inner surface of the lens assembly that faces towards the optical chip is provided with a first lens, an outer surface of the lens assembly that faces away from the circuit board is provided with a reflective surface; and one end of the lens assembly is provided with a wrapping cavity, and a second lens is disposed in the wrapping cavity; and
an optical fiber holder, in which an optical fiber is inserted, wherein the optical fiber holder is inserted in the wrapping cavity to be connected to the lens assembly, wherein
there is a gap between a fiber end-face of the optical fiber and the second lens, and a first end face of the optical fiber holder and the fiber end-face are both inclined surfaces;
the wrapping cavity comprises a stop protrusion, a surface of the stop protrusion that faces towards the optical fiber holder is a stop surface, and the stop surface is an inclined surface and is in contact with and connected to the first end face of the optical fiber holder; and
an optical signal emitted by the optical chip is transmitted to the fiber end-face through the first lens, the reflective surface and the second lens.

2. The optical module according to claim 1, wherein the first end face of the optical fiber holder comprises a grinding surface, the grinding surface and the fiber end-face are inclined surfaces of the same angle; and angles of the stop surface and the grinding surface are the same, so as to increase a contact area between the stop surface and the grinding surface when the stop surface is in contact with and connected to the grinding surface.

3. The optical module according to claim 2, wherein the first end face further comprises a step surface that has an angle different from that of the grinding surface; the stop surface comprises a first stop portion and a second stop portion, and a distance between the first stop portion and an opening of the wrapping cavity is greater than a distance between the second stop portion and the opening of the wrapping cavity, such that the second stop portion is in contact with the grinding surface while the first stop portion is not in contact with the step surface.

4. The optical module according to claim 1, wherein an angle difference between the stop surface and the first end face is −2˜2°.

5. The optical module according to claim 4, wherein angles of the first end face, the stop surface and the fiber end-face are all the same, which are all 3˜8° or 9˜13°.

6. The optical module according to claim 3, wherein a positioning column is disposed in the wrapping cavity, the second lens is located at one side of the positioning column;
the first end face is provided with a positioning hole, and the positioning column is inserted in the positioning hole, so as to achieve a connection between the optical fiber holder and the lens assembly; and
the first stop portion is located above the positioning column, and the second stop portion is located below the positioning column.

7. The optical module according to claim 6, wherein the stop protrusion has an avoidance opening, which is disposed corresponding to the positioning column to make way for the positioning column.

8. The optical module according to claim 6, wherein the positioning column comprises a first positioning column and a second positioning column; the second lens is located between the first positioning column and the second positioning column; and the stop protrusion is located outside of the first positioning column and the second positioning column.

9. The optical module according to claim 8, wherein the stop protrusion comprises a first stop protrusion and a second stop protrusion, and wherein the first stop protrusion is located at an outer side of the first positioning column, the second stop protrusion is located at an outer side of the second positioning column.

10. The optical module according to claim 1, wherein the fiber end-face does not protrude from the first end face of the optical fiber holder, such that angles of the first end face and the fiber end-face are the same.

11. The optical module according to claim 1, wherein the stop surface is located between the second lens and the optical fiber holder.

12. The optical module according to claim 1, wherein the optical fiber comprises a first optical fiber and a second optical fiber, and wherein the first optical fiber is disposed corresponding to an emission coupling lens of the second lens, such that the optical signal is coupled via the emission coupling lens to be transmitted to the first optical fiber; and
the second optical fiber is disposed corresponding to a reception collimating lens of the second lens, such that an optical signal from the second optical fiber is collimated by the reception collimating lens.

13. The optical module according to claim 6, wherein a side surface of the optical fiber holder is provided with a gap which faces towards the lens assembly;
the wrapping cavity further comprises a limiting plate and a mounting protrusion, wherein the limiting plate is disposed corresponding to the gap, the limiting plate and the mounting protrusion are respectively located at two sides of the stop protrusion, the limiting plate is protruded relative to the stop protrusion, the mounting protrusion is recessed relative to the stop protrusion, and the positioning column is disposed on the mounting protrusion; and
the mounting protrusion comprises a first mounting protrusion and a second mounting protrusion, which are respectively located on two sides of the wrapping cavity, wherein a first mounting surface and a second mounting surface are disposed between the first mounting protrusion and the second mounting protrusion, the first mounting surface and the second mounting surface are recessed relative to the mounting protrusion; the second lens is disposed on the first mounting surface and the second mounting surface, and the second mounting surface is recessed inwards relative to the first mounting surface.

14. The optical module according to claim 3, wherein
a through hole is disposed between the reflective surface and the stop protrusion, and the second lens is disposed in the through hole; and
the first stop portion is located above the through hole, and the second stop portion is located below the through hole.

15. The optical module according to claim 14, wherein the optical fiber holder comprises a ferrule configured to wrap the optical fiber; the ferrule is provided with a snapping surface; and a snapping step is disposed in the wrapping cavity, and the snapping step is disposed corresponding to the snapping surface.

16. The optical module according to claim 15, wherein the snapping step is located between the stop surface and a side surface of the wrapping cavity that is away from the stop surface.

17. The optical module according to claim 15, wherein a width of the snapping surface is larger than a width of the snapping step, and a height of the snapping step is smaller than a thickness of a cutoff portion of the ferrule corresponding to the snapping surface.

18. The optical module according to claim 15, wherein the lens assembly is provided thereon with a dispensing slot communicating with the ferrule, and wherein the dispensing slot is configured such that an adhesive is applied to a side surface of the ferrule so as to bond the side surface of the ferrule to an inner wall of the wrapping cavity;
and the dispensing slot comprises only one of a first dispensing slot and a second dispensing slot, an opening of the first dispensing slot facing upwards, and an opening of the second dispensing slot facing downwards.

19. The optical module according to claim 18, wherein the snapping surface is located at a high point of an end face of the ferrule; and the dispensing slot comprises the second dispensing slot only, the opening of the second dispensing slot facing downwards; or
the snapping surface is located at a low point of the end face of the ferrule; the dispensing slot comprises the first dispensing slot only, the opening of the first dispensing slot facing upwards.

20. An optical module, comprising:
a circuit board, on which an optical chip is disposed;
a lens assembly covered on the optical chip, wherein an inner surface of the lens assembly that faces towards the optical chip is provided with a first lens, an outer surface of the lens assembly that faces away from the circuit board is provided with a reflective surface; the lens assembly is provided with a second lens and a wrapping cavity, the wrapping cavity is disposed on one end of the lens assembly, an optical fiber holder wrapping an optical fiber is disposed in the wrapping cavity, and an inner end portion of the wrapping cavity is provided with a stop surface, the stop surface being located between the second lens and the optical fiber holder;
the stop surface is in contact with a first end face of the optical fiber holder;
there is a gap between a fiber end-face of the optical fiber and the second lens, and both the first end face and the fiber end-face are inclined surfaces of the same angle;
the stop surface is an inclined surface, and angles of the stop surface and the fiber end-face are the same; and
an optical signal emitted by the optical chip is transmitted to the fiber end-face through the first lens, the reflective surface and the second lens.
